(19) United States
(12) Patent Application Publication
(10) Pub. No.: US 2025/0277974 A1
(43) Pub. Date: Sep. 4, 2025

(54) DISPLAY SYSTEM

(71) Applicant: Panasonic Automotive Systems Co., Ltd., Kanagawa (JP)

(72) Inventors: Norihiro IMAMURA, Osaka (JP); Kenji NAGATOMI, Osaka (JP); Keiichi MATSUZAKI, Kyoto (JP); Yusuke NIHEI, Tokyo (JP); Michihiro YAMAGATA, Osaka (JP); Hirofumi HOSHIDA, Kanagawa (JP)

(73) Assignee: Panasonic Automotive Systems Co., Ltd., Kanagawa (JP)

(21) Appl. No.: 19/058,637

(22) Filed: Feb. 20, 2025

(30) Foreign Application Priority Data
Mar. 1, 2024 (JP) 2024-031098
Mar. 1, 2024 (JP) 2024-031110
Sep. 9, 2024 (JP) 2024-154389

(51) Int. Cl. G02B 27/01

(52) U.S. Cl. CPC G02B 27/0101; G02B 2027/0112; G02B 2027/0138; G02B 2027/014; G02B 2027/0141; G02B 2027/0181

(57) ABSTRACT

A display device includes a first display device that projects a first virtual image ahead of a user in a vehicle; and a second display device that projects a second virtual image ahead of the user and below the first virtual image. A lower end of the first virtual image and an upper end of the second virtual image are located within a circle whose diameter is a length of the second virtual image in a side view.

### CROSS REFERENCE TO RELATED APPLICATIONS

The present application is based on and claims priority of Japanese Patent Application No. 2024-031098 filed on Mar. 1, 2024, Japanese Patent Application No. 2024-031110 filed on Mar. 1, 2024, and Japanese Patent Application No. 2024-154389 filed on Sep. 9, 2024.

### FIELD

The present disclosure relates to a display system.

### BACKGROUND

Patent Literature (PTL) 1 discloses a display system that projects a first virtual image and a second virtual image onto positions that are approximately the same distances ahead of the user such that the user can easily view the first virtual image and the second virtual image.

### CITATION LIST

### Patent Literature

PTL 1: Japanese Unexamined Patent Application Publication No. 2015-146012

### SUMMARY

However, the foregoing display system can be improved upon.

In view of this, the present disclosure provides a display system capable of improving upon the above related art.

The display system according to an aspect of the present disclosure includes: a first display device that projects a first virtual image ahead of a user in a vehicle; and a second display device that projects a second virtual image ahead of the user and below the first virtual image, wherein a lower end of the first virtual image and an upper end of the second virtual image are located within a circle whose diameter is a length of the second virtual image in a side view.

The display system according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram showing a display system according to Embodiment 1 disposed in a vehicle.

FIG. 2 is a schematic cross-sectional diagram showing a first display device according to Embodiment 1.

FIG. 3 is a schematic cross-sectional diagram showing a second display device according to Embodiment 1.

FIG. 4 is a schematic diagram showing a display system according to Embodiment 2.

FIG. 5 is a schematic cross-sectional diagram showing a third display device according to Embodiment 2.

FIG. 6 is a schematic diagram showing a third display device according to Variation 1 of Embodiment 2.

FIG. 7 is a schematic diagram showing third display devices according to Variation 2 of Embodiment 2.

FIG. 8 is a schematic diagram showing a second display device according to Embodiment 3.

FIG. 9 is an explanatory diagram showing an example of the display performed by a display element according to Embodiment 3.

FIG. 10 is a schematic diagram showing a first display device according to Embodiment 3.

FIG. 11 is a schematic diagram showing a second display device according to Embodiment 4.

FIG. 12 is a schematic diagram showing a first display device according to Embodiment 5.

FIG. 13 is a schematic diagram showing a second display device according to Embodiment 5.

FIG. 14A is an explanatory diagram showing an example of the layout of a first virtual image and a second virtual image according to Embodiment 6.

FIG. 14B is an explanatory diagram showing an example of the layout of the first virtual image and the second virtual image according to Embodiment 6.

FIG. 14C is an explanatory diagram showing an example of the layout of the first virtual image and the second virtual image according to Embodiment 6.

FIG. 15 is a schematic diagram showing the first display device corresponding to Example Layout 3 of Embodiment 6.

FIG. 16 is a schematic diagram showing a first display device according to Embodiment 7.

FIG. 17 is a schematic diagram showing a first display device and a second display device according to Embodiment 8.

FIG. 18 is an explanatory diagram showing the first virtual image and the second virtual image in reference positions in a display system according to Embodiment 8.

FIG. 19 is an explanatory diagram showing the first virtual image and the second virtual image in the reference positions seen from a driver in Embodiment 8.

FIG. 20 is an explanatory diagram showing a state in which a large driver takes over driving, and the first display position and the second display position have been adjusted in Embodiment 8.

FIG. 21A is an explanatory diagram showing the first virtual image and the second virtual image only after the first display position has been adjusted in Embodiment 8.

FIG. 21B is an explanatory diagram showing the first virtual image and the second virtual image in the case where the first display position has been adjusted and the coordinates of the first virtual image have been adjusted in Embodiment 8.

FIG. 22 is a schematic diagram showing a display system according to Embodiment 9 disposed in a vehicle.

FIG. 23 is an explanatory diagram showing an example of displaying items of notification information according to Embodiment 9.

FIG. 24 is a schematic diagram showing a display system according to Embodiment 10.

FIG. 25 is a schematic diagram showing a display system according to Embodiment 11.

FIG. 26 is a schematic diagram showing a display system according to Embodiment 12.

FIG. 27 is an explanatory diagram showing an example of displaying items of notification information according to Embodiment 13.

FIG. 28 is an explanatory diagram showing another example of displaying a mark according to Embodiment 13.

FIG. 29 is an explanatory diagram showing another example of displaying items of notification information according to Embodiment 13.

FIG. 30 is an explanatory diagram showing an example of displaying items of notification information according to Embodiment 14.

FIG. 31 is an explanatory diagram showing an example of displaying items of notification information according to Embodiment 15.

FIG. 32 is an explanatory diagram showing another example of displaying items of notification information according to Embodiment 15.

FIG. 33 is a schematic diagram showing a display system according to Embodiment 16.

FIG. 34 is an explanatory diagram showing an example of the display performed by a second display device according to Embodiment 16.

FIG. 35 is an explanatory diagram showing an example of displaying video according to Embodiment 16.

FIG. 36 is an explanatory diagram showing another example of the display according to Embodiment 16.

FIG. 37 is a schematic diagram showing a display system according to Embodiment 17.

FIG. 38 is a schematic diagram showing a display system according to Embodiment 18.

FIG. 39 is an explanatory diagram showing an example of displaying notification information according to Embodiment 18.

FIG. 40 is an explanatory diagram showing another example of displaying notification information according to Embodiment 18.

FIG. 41 is an explanatory diagram showing another example of displaying notification information according to Embodiment 18.

FIG. 42 is a schematic diagram showing another example of the display system according to Embodiment 18.

FIG. 43 is a schematic diagram showing a display system according to Embodiment 19.

FIG. 44 is a schematic diagram showing a display system according to Embodiment 20.

FIG. 45 is a schematic diagram showing the display system according to Embodiment 20.

FIG. 46 is a schematic diagram showing the display system according to Embodiment 20.

### DESCRIPTION OF EMBODIMENTS

### Underlying Knowledge Forming Basis of the Present Disclosure

In recent years, there has been a demand for further alleviating the burden on a user in viewing different virtual images. Stated differently, the present disclosure provides a display system capable of alleviating the burden on a user in viewing different virtual images.

The display system according to an aspect of the present disclosure includes: a first display device that projects a first virtual image ahead of a user in a vehicle; and a second display device that projects a second virtual image ahead of the user and below the first virtual image, wherein a lower end of the first virtual image and an upper end of the second virtual image are located within a circle whose diameter is a length of the second virtual image in a side view.

With this, the lower end of the first virtual image and the upper end of the second virtual image are located within the circle whose diameter is the length of the second virtual image in a side view. This enables the lower end of the first virtual image and the upper end of the second virtual image to be located in proximity to each other in the up-down direction. This reduces each of the gap in the up-down direction and the gap in the horizontal direction between the lower end of the first virtual image and the upper end of the second virtual image. It is thus possible to alleviate the burden on the user caused by moving his/her viewpoint and focus point, switching between the first virtual image and the second virtual image, in viewing these virtual images.

Also, a difference between a first angle of depression and a second angle of depression may be 12° or less, the first angle of depression being an angle formed by the lower end of the first virtual image with respect to a viewpoint of the user, the second angle of depression being an angle formed by the upper end of the second virtual image with respect to the viewpoint of the user.

With this, the difference between the first angle of depression formed by the lower end of the first virtual image with respect to the viewpoint of the user and the second angle of depression formed by the upper end of the second virtual image with respect to the viewpoint of the user is 12° or less. This further reduces the gap in the up-down direction between the lower end of the first virtual image and the upper end of the second virtual image. It is thus possible to further alleviate the burden on the user caused by moving his/her viewpoint and focus point, switching between the first virtual image and the second virtual image, in viewing these virtual images.

Also, the display system may include a third display device that projects a third virtual image ahead of the user, and the third virtual image may be located at a viewing distance of 0.25 diopters or less with respect to a viewing distance of the second virtual image.

With this, the third virtual image is located at the viewing distance of 0.25 diopters or less with respect to the viewing distance of the second virtual image. This reduces the gap in the horizontal direction between the second virtual image and the third virtual image. It is thus possible to alleviate the burden on the user caused by moving his/her viewpoint and focus point, switching between the second virtual image and the third virtual image, in viewing these virtual images.

Also, at least one of the first virtual image projected by the first display device or the second virtual image projected by the second display device may be displayed in a plurality of layers.

With this, at least one of the first virtual image or the second virtual image is displayed in a plurality of layers. This enables different contents to be displayed on a layer-by-layer basis, thereby enabling more diverse content representation.

Also, the second display device may include: a display element that emits video light for forming the second virtual image; and an optical system for projecting the video light from the display element as the second virtual image, and the optical system may include a concave mirror that reflects the video light at a final stage.

With this, the second virtual image is formed by means of the concave mirror reflecting and converging the video light at the final stage. It is thus possible to easily secure the viewing distance of the second virtual image.

Also, at least one of the first display device or the second display device may include an adjuster for adjusting the viewing distance of the first virtual image and the viewing distance of the second virtual image.

With this, at least one of the first display device or the second display device includes the adjuster for adjusting the viewing distance of the first virtual image and the viewing distance of the second virtual image. This enables the adjustment of the viewing distance of at least one of the first virtual image or the second virtual image. With this, it is possible to adjust the viewing distance of at least one of the first virtual image or the second virtual image by means of the adjuster, in accordance with various conditions. This enables more diverse content representation.

Also, the display system may include a controller that controls a display content of the first display device and a display content of the second display device.

With this, the controller controls the display content of the first display device and the display content of the second display device. It is thus possible for the controller to collectively control the display content of the first display device (display content of the first virtual image) and the display content of the second display device (display content of the second virtual image). This facilitates the content coordination between the first virtual image and the second virtual image.

Also, at least one of the first display device or the second display device may include an optical system that includes a hologram element.

With this, at least one of the first display device or the second display device includes the optical system that includes the hologram element. It is thus possible for at least one of the first display device or the second display device to have a low-profile optical system.

Also, the display system may include a first position adjuster that adjusts a first display position in an up-down direction of the first virtual image; a second position adjuster that adjusts a second display position in an up-down direction of the second virtual image; and a coordinate changer that changes coordinates of the first virtual image within a displayable range of the first virtual image, based on the first display position and the second display position that have been adjusted.

With this, the display system includes the first position adjuster, the second position adjuster, and the coordinate changer. Thus, even when the viewpoint position of the driver has changed, it is possible to also adjust the coordinates of the first virtual image within the displayable range, while adjusting the first display position of the first virtual image and the second display position of the second virtual image. This enables the first virtual image and the second virtual image to be suitably displayed also for a different driver.

Also, the first display device may include a first reflector that reflects video light for forming the first virtual image, the second display device may include a second reflector that reflects video light for forming the second virtual image, the first position adjuster may adjust at least one of an orientation or a position of the first reflector to adjust the first display position of the first virtual image, and the second position adjuster may adjust at least one of an orientation or a position of the second reflector to adjust the second display position of the second virtual image.

With this, the first position adjuster adjusts the first display position of the first virtual image by adjusting at least one of the orientation or the position of the first reflector. It is thus possible to adjust the first display position using a simple structure. Meanwhile, the second position adjuster adjusts the second display position of the second virtual image by adjusting at least one of the orientation or the position of the second reflector. It is thus possible to adjust the second display position using a simple structure. These enable the first virtual image and the second virtual image to be suitably displayed also for a different driver.

Also, the display system may include a head imager that captures an image of a head of the user; an estimator that estimates a viewpoint position of the user, based on the image captured by the head imager; and an adjustment controller that controls the first position adjuster and the second position adjuster, based on the viewpoint position of the user estimated.

With this, the estimator estimates the viewpoint position of the user, on the basis of the image captured by the head imager, and the adjustment controller controls the first position adjuster and the second position adjuster, on the basis of such estimated viewpoint position. It is thus possible to automatically adjust the first display position and the second display position.

Also, the display system may include a first imager that captures images of surroundings of the vehicle; and a controller that controls the first display device, the second display device, and the first imager. When the controller causes each of the first display device and the second display device to display notification information to be provided to the user, the controller may adjust, between the first display device and the second display device, at least one of luminance, a size, or chromaticity of the notification information to be displayed together with vehicle surrounding information obtained from the first imager.

With this, when the notification information is displayed by each of the first display device and the second display device, at least one of the luminance, the size, or the chromaticity of the notification information to be displayed together with the vehicle surrounding information obtained from the first imager is adjusted between the first display device and the second display device. It is thus possible to display the notification information displayed by the first display device and the notification information displayed by the second display device in a visually uniform (consistent) manner. This reduces the user's sense of discomfort that occurs when such user views the notification information in the first virtual image and the notification information in the second virtual image.

Also, the first imager may capture the images of an area ahead of the vehicle, and the controller may calculate luminance of the first virtual image in a state of being overlaid on a background, based on the vehicle surrounding information, and adjust the luminance of the notification information between the first display device and the second display device, based on a calculation result.

With this, the luminance of the first virtual image in the state of being overlaid on the background is calculated on the basis of the vehicle surrounding information. Then, on the basis of the calculation result, the luminance of each of the items of notification information is adjusted between the first display device and the second display device. With this, it is possible to reflect, on the luminance of each of the items of notification information, the influence of the background exerted on the luminance of the first virtual image. This enables information notification that creates a lesser sense of discomfort.

Also, the controller may adjust the luminance of the notification information between the first display device and the second display device to cause the luminance of the notification information in the first virtual image and the luminance of the notification information in the second virtual image to be approximately same.

With this, the luminance of the notification information in the first virtual image and the luminance of the notification information in the second virtual image are adjusted to be approximately the same. It is thus possible to reduce the difference in the luminance between the notification information in the first virtual image and the notification information in the second virtual image. This further reduces the user's sense of discomfort that occurs when such user views the notification information in the first virtual image and the notification information in the second virtual image.

The controller may adjust the luminance of the notification information between the first display device and the second display device to cause the luminance of the notification information in the first virtual image to be higher than the luminance of the notification information in the second virtual image.

With this, the luminance of the notification information in the first virtual image is adjusted to be higher than the luminance of the notification information in the second virtual image. It is thus possible to make the notification information in the first virtual image, which is located above the second virtual image, more stand out. This enables the user to more easily recognize the notification information in the first virtual image.

The controller may adjust the luminance of the notification information between the first display device and the second display device to cause the luminance of the notification information in the first virtual image to be lower than the luminance of the notification information in the second virtual image.

With this, the luminance of the notification information in the first virtual image is adjusted to be lower than the luminance of the notification information in the second virtual image. It is thus possible to make the notification information in the second virtual image, which is displayed below the first virtual image and thus directs the line of sight of the user downward, more stand out.

The display system may further include a second imager that captures an image of surroundings of the user, and the controller may adjust the luminance of the notification information between the first display device and the second display device, on the basis of user surrounding information obtained from the second imager.

With this, it is possible to obtain the user surrounding information by means of the second imager. This enables to have an accurate grasp of the viewpoint position of the user, on the basis of such user surrounding information. With this, it is possible to have an accurate grasp of the luminance viewed by the user from the viewpoint position, thereby reflecting such luminance on the luminance of each of the items of notification information. This thus enables information notification that creates a lesser sense of discomfort.

The display system may further include an illuminance sensor that detects an illuminance of an area in the vicinity of the second display device, and the controller may adjust the luminance the notification information between the first display device and the second display device, based on a detection result of the illuminance sensor.

With this, the luminance of the notification information is adjusted on the basis of the detection result of the illuminance sensor. It is thus possible to reflect the illuminance of the area in the vicinity of the second display device on the luminance of each of the items of notification information. This thus enables information notification that creates a lesser sense of discomfort.

The display system may further include a second imager that captures an image of surroundings of the user, and the controller may adjust the size of the notification information between the first display device and the second display device, on the basis of user surrounding information obtained from the second imager.

With this, it is possible to obtain the user surrounding information by means of the second imager. This enables to have an accurate grasp of the viewpoint position of the user, on the basis of such user surrounding information. With this, it is possible to accurately adjust the size of each of the items of notification information viewed by the user from the viewpoint position, thereby enabling information notification that creates a lesser sense of discomfort.

The first imager may capture the images of an area ahead of the vehicle, and the controller may calculate chromaticity of the first virtual image in a state of being overlaid on a background, based on the vehicle surrounding information, and adjust, between the first display device and the second display device, the chromaticity of the notification information in the first virtual image and the chromaticity of the notification information in the second virtual image to be approximately same, based on a calculation result.

With this, the chromaticity of the first virtual image in the state of being overlaid on the background is calculated on the basis of the vehicle surrounding information. Then, on the basis of the calculation result, the chromaticity of the notification information in the first virtual image and the chromaticity of the notification information in the second virtual image are adjusted to be approximately the same. With this, it is possible to adjust the chromaticity of the notification information in the first virtual image and the chromaticity of the notification information in the second virtual image to be approximately the same, in consideration of the influence of the background exerted on the first virtual image. This enables information notification that creates a lesser sense of discomfort.

Also, the controller may adjust the chromaticity of the notification information in the first virtual image, with the chromaticity of the notification information in the second virtual image kept constant.

With this, the chromaticity of the notification information in the first virtual image is adjusted, with the chromaticity of the notification information in the second virtual image kept constant. It is enables the notification information in the first virtual image to be more easily viewed.

The controller may adjust the chromaticity of the notification information in the second virtual image to be approximately the same as the chromaticity of the notification information in the first virtual image, with the chromaticity of the notification information in the first virtual image kept constant.

With this, the chromaticity of the notification information in the second virtual image is adjusted to be approximately the same as the chromaticity of the notification information in the first virtual image, with the chromaticity of the notification information in the first virtual image kept constant. This enables the chromaticity of the notification information in the first virtual image to be less likely to change, thus alleviating the burden on the user when looking ahead.

The display system may further include a second imager that captures an image of surroundings of the user, and the controller may adjust the chromaticity of the notification information between the first display device and the second display device, based on user surrounding information obtained from the second imager.

With this, it is possible to obtain the user surrounding information by means of the second imager. This enables to have an accurate grasp of the viewpoint position of the user, on the basis of such user surrounding information. With this, it is possible to have an accurate grasp of the chromaticity viewed by the user from the viewpoint position, thereby reflecting such chromaticity on the chromaticity of each of the items of notification information. This thus enables information notification that creates a lesser sense of discomfort.

Also, the controller may cause the notification information to be displayed, based on a display reference point that is set inside a first display area of the first display device. When a target object for which the notification information is provided is present inside the first display area, the controller may set the target object as the display reference point, and when the target object for which the notification information is provided is present outside the first display area, the controller may set the display reference point on a center line in a width direction of the first display area.

With this, when the target object for which each of the items of notification information is displayed is present inside the first display area, the items of notification information are displayed, with such target object serving as the display reference point. This enables the user to also recognize the target object simply by viewing the items of notification information. Meanwhile, when the target object for which each of the items of notification information is displayed is present outside the first display area, the notification information is displayed on the display reference point that is set on the center line in the width direction of the first display area. Stated differently, since the notification information is located on the center line in the first display area, when the target object is not present inside the first display area, it is possible for the user to more reliably view the notification information.

Also, the controller may cause the notification information displayed by the first display device and the notification information displayed by the second display device to be located on a straight line that includes the display reference point.

With this, the notification information displayed by the first display device and the notification information displayed by the second display device are located on the straight line that includes the display reference point. It is thus possible for the user to linearly move the line of sight to each notification information. This alleviates the burden on the user caused by moving the line of sight.

Also, the controller may cause the notification information displayed by the first display device and the notification information displayed by the second display device to be displayed in a continuous manner.

With this, the notification information displayed by the first display device and the notification information displayed by the second display device are displayed in a continuous manner. It enables the user to more easily recognize the positional relationship between the items of notification information.

Also, the controller may cause the notification information displayed by the first display device and the notification information displayed by the second display device to be displayed in a manner that each of the notification information displayed by the first display device and the notification information displayed by the second display device moves from the first display area of the first display device toward a second display area of the second display device.

With this, the notification information displayed by the first display device and the notification information displayed by the second display device are displayed in a manner that these items of notification information move from the first display area to the second display area. This makes it easy to guide the line of sight of the user.

Also, the controller may cause the second display device to display video captured by the first imager.

With this, the video captured by the first imager is displayed by the second display device. It is thus possible to display the video captured by the first imager and the notification information displayed by the second display device in an overlaid manner. This enables the notification information to be displayed on a clear video, thereby enabling content representation that is easy for the user to understand.

Also, the display device may include a side imager that captures video of surroundings of a lateral side of the vehicle, and the controller may cause the second display device to display a pseudo image overlaid on the video captured by the side imager, the pseudo image being an image that mimics an interior of the vehicle as a blind spot of the user.

With this, the controller causes the second display device to display the pseudo image, which mimics the interior of the vehicle as a blind spot portion of the user, in a manner that such pseudo image is overlaid on the video captured by the side imager. It is thus possible for the user to view the pseudo image displayed by the second display device and the video captured by the side imager. This enables the user to recognize the situations on the lateral sides of the vehicle and the blind spot, and thus have a grasp of the surrounding situation of the vehicle.

The display system may include a tilt sensor that obtains a tilt of the vehicle, and the controller may correct the video captured by the side imager, based on a detection result of the tilt sensor, to cause the second display device to display the video corrected.

With this, the second display device displays the video that has been corrected on the basis of the detection result of the tilt sensor. It is thus possible for the user to have a more accurate grasp of the surrounding situation of the vehicle.

Also, the display device may include a generator that generates a sound or a vibration, and the controller may cause the generator to generate the sound or the vibration, based on a display timing of the notification information.

With this, the generator generates the sound or the vibration on the basis of the display timing of the items of notification information. It is thus possible for the user to more reliably have a grasp of the notification information in response to the sound or the vibration.

The first display device may include: an augmented reality head-up display that projects one portion of the first virtual image; and a head-up display that projects another portion of the first virtual image.

With this, the first virtual image is formed by the augmented reality head-up display and the head-up display. It is thus possible to perform more diverse representation of the first virtual image.

### EMBODIMENTS

Hereinafter, certain exemplary embodiments are described in greater detail with reference to the accompanying Drawings. Each of the exemplary embodiments described below shows a general or specific example. The numerical values, shapes, materials, elements, the arrangement and connection of the elements, steps, the processing order of the steps etc. shown in the following exemplary embodiments are mere examples, and therefore do not limit the scope of the present disclosure. Therefore, among the elements in the following exemplary embodiments, those not recited in any one of the independent claims are described as optional elements.

In the following embodiments, expressions that indicate relative orientations of two directions, such as “parallel” and “orthogonal”, are used in some cases, but these expressions also mean the case where the two directions are not in such orientations in a strict sense. When the two directions are described as being parallel, for example, such expression not only means that the two directions are perfectly parallel, but also that the two directions are substantially parallel, unless otherwise stated. Stated differently, the expression also means that an error on the order of a few percent, for example, is allowed. Also, in the following embodiments, optical paths illustrated in the drawings are intended to show how the optical paths are interpreted in principle, and thus do not necessarily show the actual optical paths.

### Embodiment 1

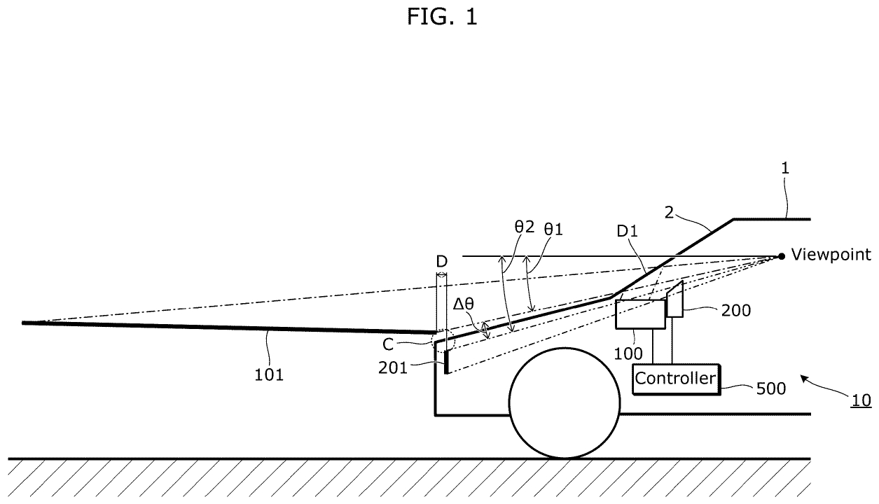

FIG. 1 is a schematic diagram showing display system 10 according to Embodiment 1 disposed in vehicle 1. In FIG. 1, vehicle 1 is shown in cross-section.

As shown in FIG. 1, display system 10 includes first display device 100, second display device 200, and controller 500. First display device 100 and second display device 200 are disposed, for example, on the dashboard of vehicle 1. First display device 100 and second display device 200 display vehicle information related to vehicle 1, for example, as first virtual image 101 and second virtual image 201. Examples of the vehicle information include the vehicle speed of vehicle 1, the number of revolutions of the engine, a detection result on an object that is present in the proximity of vehicle 1, navigation information from the current position of vehicle 1 to the destination, image information captured by a camera that captures images of the rear and surroundings of vehicle 1, etc. Note that FIG. 1 shows an example case where first display device 100 and second display device 200 are disposed on the dashboard, but the position where first display device 100 and second display device 200 is disposed is not limited to this; first display device 100 and second display device 200 may be disposed, for example, in the vicinity of the upper end of windshield 2 or in the center console.

### [First Display Device]

First display device 100 is an augmented reality head-up display (AR-HUD). First display device 100 projects light onto region D1 in windshield (windscreen) 2 serving as a display medium. The projected light is reflected by windshield 2. Such reflected light travels toward the eyes of the driver seated in the driver's seat, who is the user of first display device 100. The driver perceives the reflected light that has entered his/her eyes as first virtual image 101 that is seen on the opposite side across windshield 2 (outside the vehicle), against the actual objects seen across windshield 2 serving the background.

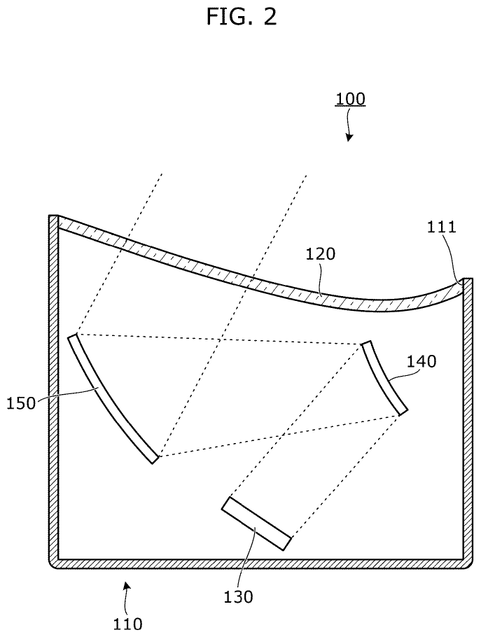

The following describes the configuration of first display device 100 with reference to FIG. 2. FIG. 2 is a schematic cross-sectional diagram showing first display device 100 according to Embodiment 1.

As shown in FIG. 2, first display device 100 includes housing 110, cover 120, display element 130, first optical element 140, and second optical element 150. First optical element 140 and second optical element 150 are optical systems for projecting video light from display element 130 as first virtual image 101.

Housing 110 is a box-shaped body formed of lightproof resin or metal. More specifically, housing 110 has an approximately prismatic shape, and includes opening 111 that is provided in an upper portion thereof. Opening 111 is closed by cover 120. The internal space defined by housing 110 and cover 120 accommodates display element 130, first optical element 140, and second optical element 150.

Cover 120 is, for example, a curved plate body formed of a translucent resin or glass. More specifically, cover 120 has a shape that is convex downward as a whole.

Display element 130 is, for example, a liquid-crystal panel. When irradiated with light from a light source not shown, display element 130 emits, to first optical element 140, video light to serve as first virtual image 101. Display element 130 may also be an organic electro-luminescence (EL) panel. Display element 130 has a rectangular shape in a plan view and is disposed at an angle relative to the horizontal plane.

First optical element 140 is an optical element that is disposed on the optical path of the video light from display element 130 and reflects the video light toward second optical element 150. First optical element 140 is a convex mirror having a rectangular shape in a plan view. First optical element 140 is disposed at an angle relative to the vertical plane. The reflecting surface of first optical element 140 faces display element 130 and second optical element 150. Stated differently, in first optical element 140, the reflecting surface, which is the mirror surface of the convex mirror, faces inward of housing 110, and the concave surface faces outward of housing 110.

Second optical element 150 is an optical member that is disposed on the optical path of the video light which has passed through first optical element 140 and that reflects the video light reflected by first optical element 140 toward opening 111. More specifically, second optical element 150 is a concave mirror having a rectangular shape in a plan view. Second optical element 150 faces the reflecting surface of first optical element 140 and is disposed at an angle relative to the vertical plane of housing 110. The reflecting surface of second optical element 150 faces first optical element 140 and cover 120. Stated differently, in second optical element 150, the reflecting surface, which is the mirror surface of the concave mirror, faces inward of housing 110, and the convex surface faces outward of housing 110. The video light reflected by second optical element 150 is projected onto windshield 2 via opening 111. This reflection causes the video light to travel toward the eyes of the driver seated in the driver's seat to serve as first virtual image 101. FIG. 1 shows the position of first virtual image 101 that is seen from the viewpoint of the driver. It is possible to set this position by adjusting the viewing distance of the video light from display element 130 of first display device 100. The viewing distance is the distance from the viewpoint of the driver to the imaging position of a virtual image (e.g., first virtual image 101). The viewpoint of the driver is, for example, the reference eyepoint. The reference eyepoint is “the point that represents the position of the eyes of the driver under normal driving conditions”.

### [Second Display Device]

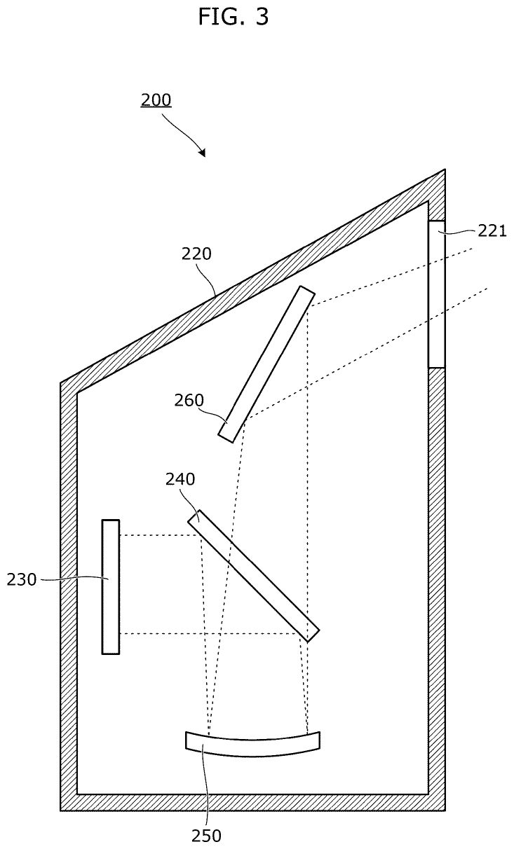

As shown in FIG. 1, second display device 200 projects the video light toward the driver. The driver perceives the video light that has entered his/her eyes as second virtual image 201 that appears in a distant position from opening 221 of second display device 200 (see FIG. 3).

The following describes the configuration of second display device 200 with reference to FIG. 3. FIG. 3 is a schematic cross-sectional diagram showing second display device 200 according to Embodiment 1. As shown in FIG. 3, second display device 200 includes housing 220, display element 230, polarizing half mirror 240, first reflecting mirror 250, and second reflecting mirror 260. Polarizing half mirror 240, first reflecting mirror 250, and second reflecting mirror 260 are optical systems for projecting the video light from display element 230 as second virtual image 201.

Housing 220 is a box-shaped body formed of lightproof resin or metal. Opening 221 that faces rearward is provided at an upper end portion of the rear part of housing 220 (rightward direction in FIG. 3 is defined as the rear part and rearward). Video light to serve as second virtual image 201 is projected from opening 221. The internal space defined by housing 220 accommodates display element 230, polarizing half mirror 240, first reflecting mirror 250, and second reflecting mirror 260.

Display element 230 is, for example, a liquid-crystal panel. When irradiated with light from a light source not shown, display element 230 emits, to polarizing half mirror 240, the video light to serve as second virtual image 201. Display element 230 may also be an organic EL panel. Display element 230 is disposed in an orientation in which the display surface faces rearward. Although not shown, a λ/4 phase difference plate (hereafter, abbreviated as “λ/4 plate”) is stacked on the display surface of display element 230. The λ/4 plate is a λ/4 phase difference plate that causes a phase difference of ¼ wavelength λ in light that has entered such λ/4 plate. When the light outputted from the display surface is linear S-polarized light, for example, such light is converted into circularly polarized light by passing through the λ/4 plate.

Polarizing half mirror 240 is configured to reflect P-polarized light and transmit S-polarized light. In polarizing half mirror 240, a reflective polarizing plate is disposed on a glass substrate having a flat plate shape. In addition, a λ/4 plate is stacked on the surface of polarizing half mirror 240. Polarizing half mirror 240 is disposed in an orientation in which polarizing half mirror 240 faces display element 230 and first reflecting mirror 250. The S-polarized video light outputted from display element 230 is converted into circularly polarized light by the λ/4 plate stacked on display element 230, and then travels toward polarizing half mirror 240. Such circularly polarized video light is converted into P-polarized light by the λ/4 plate stacked on polarizing half mirror 240, and reflected by the reflective polarizing plate of polarizing half mirror 240. The reflected P-polarized video light is converted into circularly polarized light by passing through the λ/4 plate again. Thus, polarizing half mirror 240 is disposed in an orientation in which the video light that has entered as circularly polarized light is reflected by the λ/4 plate and the reflective polarizing plate stacked on polarizing half mirror 240 toward first reflecting mirror 250 as circularly polarized light.

First reflecting mirror 250 is a concave mirror and disposed below polarizing half mirror 240 in FIG. 3. First reflecting mirror 250 is disposed in an orientation in which the concave surface serving as the reflecting surface faces upward. The circularly polarized video light reflected by polarizing half mirror 240 is reflected by first reflecting mirror 250 as it is, that is, as circularly polarized light, and then travels toward polarizing half mirror 240 again. The video light that has entered polarizing half mirror 240 is converted into S-polarized light by the λ/4 plate stacked on polarizing half mirror 240, and then passes through the reflective polarizing plate of polarizing half mirror 240 to travel upward in FIG. 3.

Second reflecting mirror 260 is a flat mirror and disposed above polarizing half mirror 240. For this reason, the video light that passes through polarizing half mirror 240 and travels upward is reflected by second reflecting mirror 260. Second reflecting mirror 260 is disposed in an orientation in which second reflecting mirror 260 reflects such video light toward opening 221. Stated differently, the video light reflected by second reflecting mirror 260 travels toward the eyes of the driver seated in the driver's seat via opening 221 to be second virtual image 201. FIG. 1 shows the position of second virtual image 201 that is seen from the viewpoint of the driver. It is possible to adjust this position by adjusting the imaging position of the video light emitted from display element 230 of second display device 200.

### [Controller]

As shown in FIG. 1, controller 500 is electrically connected to first display device 100 and second display device 200 to collectively control the display contents of display elements 130 and 230. More specifically, controller 500 includes a CPU, a RAM, a ROM, etc., and each process is executed by the CPU loading, in the RAM, a program stored in the ROM and executing such program.

### [Positional Relationship Between First Virtual Image and Second Virtual Image]

The following describes the positional relationship between first virtual image 101 and second virtual image 201. As shown in FIG. 1, first virtual image 101 is formed to be at an angle relative to the horizontal plane in a side view of vehicle 1. More specifically, first virtual image 101 is located at an angle such that the lower end of first virtual image 101 is at the rearmost point in the traveling direction of vehicle 1 and the upper end of first virtual image 101 is at the foremost point in the traveling direction of vehicle 1.

Second virtual image 201 is located below first virtual image 101 in a side view of vehicle 1. Second virtual image 201 is formed to be parallel to the vertical plane of vehicle 1. The lower end of first virtual image 101 and the upper end of second virtual image 201 are located within circle C whose diameter is the length of second virtual image 201 in a side view. The length of second virtual image 201 is the entire length of second virtual image 201 in a side view of vehicle 1. In the present embodiment, since second virtual image 201 is located parallel to the vertical plane, the length of second virtual image 201 is the length in the vertical direction (up-down direction).

As described above, since the lower end of first virtual image 101 and the upper end of second virtual image 201 are located within circle C in a side view, it is possible to reduce each of the gap in the up-down direction and gap D in the horizontal direction between the lower end of first virtual image 101 and the upper end of second virtual image 201. Here, the horizontal direction is the horizontal direction in a side view of vehicle 1, that is, the front-back direction of vehicle 1.

Here, when assuming that difference Δθ between first angle of depression θ1 formed by the lower end of first virtual image 101 with respect to the viewpoint of the driver and second angle of depression θ2 formed by the upper end of second virtual image 201 with respect to the viewpoint of the driver is 12° or less, the lower end of first virtual image 101 and the upper end of second virtual image 201 are located within circle C in a side view and the gap in the up-down direction between the lower end of first virtual image 101 and the upper end of second virtual image 201 can be further reduced.

Note that, to further reduce the gap in the up-down direction between the lower end of first virtual image 101 and the upper end of second virtual image 201, difference Δθ may be, for example, 10° or less, and more preferably 6° or less.

### Effects, Etc.

As described above, according to the present embodiment, the lower end of first virtual image 101 and the upper end of second virtual image 201 are located within circle C whose diameter is the length of second virtual image 201 in a side view. This enables the lower end of first virtual image 101 and the upper end of second virtual image 201 to be located in proximity to each other in the up-down direction. With this, each of the gap in the up-down direction and gap D in the horizontal direction between the lower end of first virtual image 101 and the upper end of second virtual image 201 is reduced. It is thus possible to alleviate the burden on the driver caused by moving his/her viewpoint and focus point, switching between first virtual image 101 and second virtual image 201, in viewing these virtual images. Note that, from the standpoint of reducing the foregoing gaps, the diameter of circle C may be, for example, a half of the entire length of second virtual image 201, and more preferably a quarter of the entire length.

Also, since difference Δθ between first angle of depression θ1 formed by the lower end of first virtual image 101 with respect to the viewpoint of the driver and second angle of depression θ2 formed by the upper end of second virtual image 201 with respect to the viewpoint of the driver is 12° or less, it is possible to further reduce the gap in the up-down direction between the lower end of first virtual image 101 and the upper end of second virtual image 201. This further alleviates the burden on the driver caused by moving his/her viewpoint and focus point, switching between first virtual image 101 and second virtual image 201, in viewing these virtual images.

Also, since controller 500 controls the display content of first display device 100 and the display content of second display device 200, it is possible for controller 500 to collectively control the display content of first display device 100 (display content of first virtual image 101) and the display content of second display device 200 (display content of second virtual image 201). This facilitates the content coordination between first virtual image 101 and second virtual image 201.

### Embodiment 2

The following describes Embodiment 2. In the following description, the same reference signs are assigned to the same parts as those of Embodiment 1, and the description of these parts may be omitted.

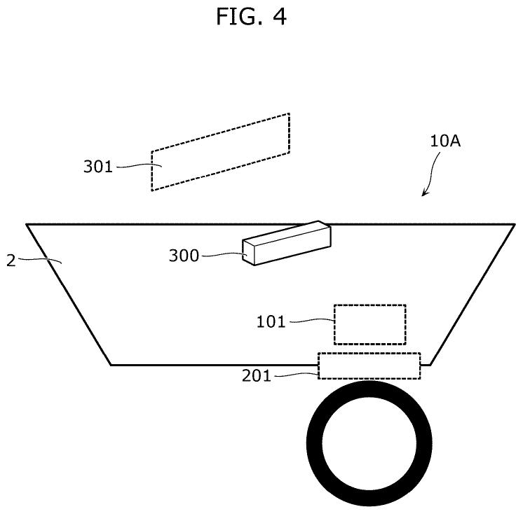

FIG. 4 is a schematic diagram showing display system 10A according to Embodiment 2. As shown in FIG. 4, display system 10A further includes third display device 300 that projects third virtual image 301 ahead of the driver. Third display device 300 is disposed in the vicinity of the upper end of windshield 2 and serves as an electronic inner mirror capable of displaying, as third virtual image 301, camera video of the rear of the vehicle.

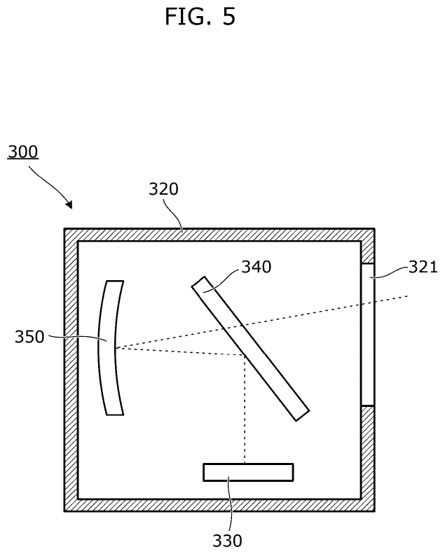

FIG. 5 is a schematic cross-sectional diagram showing third display device 300 according to Embodiment 2. As shown in FIG. 5, third display device 300 includes housing 320, display element 330, polarizing half mirror 340, and reflecting mirror 350.

Housing 320 is a box-shaped body formed of lightproof resin or metal. Opening 321 that faces rearward (defined as the rightward direction in FIG. 5) is provided in an upper end portion (defined as the upper side in FIG. 5) of the rear part (defined as the right side in FIG. 5) of housing 320. Video light to serve as third virtual image 301 is projected from opening 321. The internal space defined by housing 320 accommodates display element 330, polarizing half mirror 340, and reflecting mirror 350.

Display element 330 is, for example, a liquid-crystal panel. When irradiated with light from a light source not shown, display element 330 emits, to polarizing half mirror 340, video light to serve as third virtual image 301. Display element 330 may also be an organic EL panel. Display element 330 is disposed in an orientation in which the display surface faces upward (defined as the upper side in FIG. 5). Although not shown, a λ/4 plate is stacked on the display surface of display element 330.

Polarizing half mirror 340 is configured to reflect S-polarized light and transmit P-polarized light. More specifically, in polarizing half mirror 340, a reflective polarizing plate is disposed on a glass substrate having a flat plate shape. Polarizing half mirror 340 is disposed in an orientation in which polarizing half mirror 340 reflects the video light outputted from display device 330 toward reflecting mirror 350. Although not shown, a λ/4 plate is stacked on the surface of polarizing half mirror 340 that faces display element 330.

Reflecting mirror 350 is a concave mirror and is disposed in the forward direction of polarizing half mirror 340. Reflecting mirror 350 is disposed in an orientation in which the concave surface serving as the reflecting surface faces rearward. Reflecting mirror 350 is disposed in an orientation in which reflecting mirror 350 reflects the video light that has transmitted through polarizing half mirror 340 toward opening 321.

The P-polarized video light emitted from display element 330 enters the λ/4 plate to be converted into circularly polarized light, and then travels toward polarizing half mirror 340. Such video light enters the λ/4 plate on polarizing half mirror 340 to be converted into S-polarized light, and then reflected by polarizing half mirror 340. After that, the video light further enters the λ/4 plate to be converted into circularly polarized light and then travels toward reflecting mirror 350 to be reflected by reflecting mirror 350. Subsequently, the video light enters the λ/4 plate on polarizing half mirror 340 to be converted into P-polarized light, and then transmits through polarizing half mirror 340 to travel toward opening 321. The video light that has passed through opening 321 travels toward the eyes of the driver seated in the driver's seat to be third virtual image 301 (see FIG. 4).

Here, when third virtual image 301 is located at a viewing distance of 0.25 diopters or less with respect to the viewing distance of second virtual image 201, it is possible to reduce the gap in the horizontal direction between second virtual image 201 and third virtual image 301. It is thus possible to alleviate the burden on the driver caused by moving his/her viewpoint and focus point, switching between second virtual image 201 and third virtual image 301, in viewing these virtual images. Note that “diopter” is defined as the absolute value of the difference between the reciprocal of the distance from the viewpoint to the left end of second virtual image 201 and the reciprocal of the distance from the viewpoint to the right end of third virtual image 301.

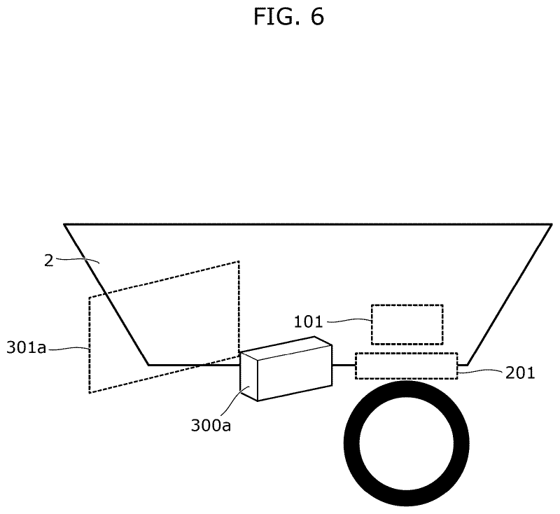

FIG. 6 is a schematic diagram showing third display device 300a according to Variation 1 of Embodiment 2. As shown in FIG. 6, third display device 300a is disposed in the vicinity of the center of the lower end of windshield 2 and serves as a car navigation device that displays, for example, car navigation information as third virtual image 301a.

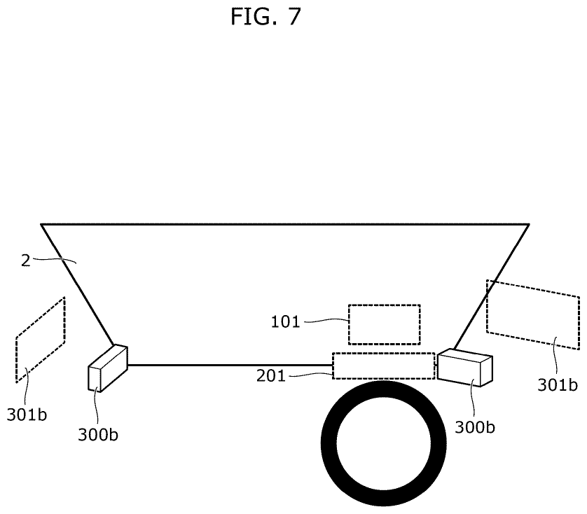

FIG. 7 is a schematic diagram showing third display devices 300b according to Variation 2 of Embodiment 2. As shown in FIG. 7, third display devices 300b are disposed on the both sides of the lower end of windshield 2 and serve as electronic inner mirrors capable of displaying, as third virtual images 301b, camera video of the side rear of vehicle 1.

### Embodiment 3

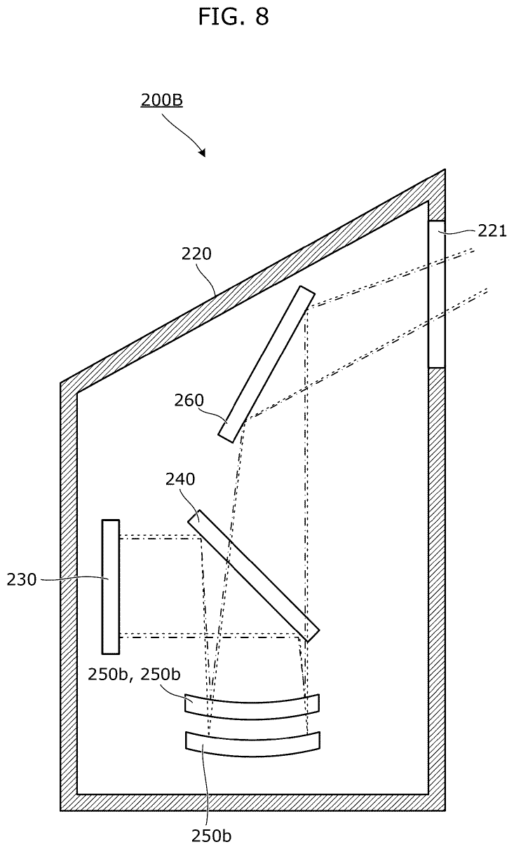

The following describes Embodiment 3. FIG. 8 is a schematic diagram showing second display device 200B according to Embodiment 3. As shown in FIG. 8, second display device 200B includes three first reflecting mirrors 250b. Three first reflecting mirrors 250b are arranged along the longitudinal direction (normal direction on the plane of the diagram) of display element 230. Of these three first reflecting mirrors 250b, first reflecting mirror 250b in the middle is located at the bottommost in FIG. 8, and the other two first reflecting mirrors 250b are located above first reflecting mirror 250b in the middle and at the same position in a side view in FIG. 8.

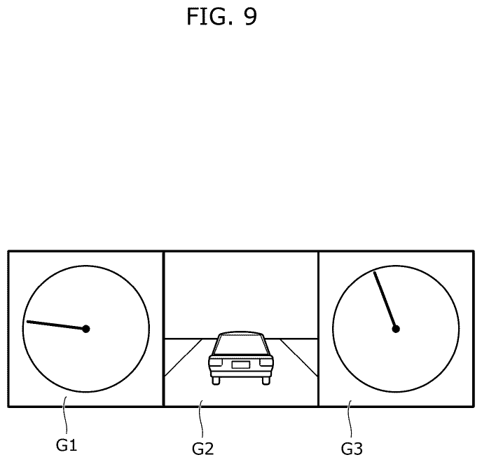

FIG. 9 is an explanatory diagram showing an example of the display performed by display element 230 according to Embodiment 3. As shown in FIG. 9, display element 230 is divided into three parts in the longitudinal direction, and these parts form different videos G1, G2, and G3. Here, video G2 at the center (which shows, for example, the state of the cruise control of the vehicle) corresponds to first reflecting mirror 250b in the middle, and the other two videos G1 and G3 (which show, for example, the speedometer and the engine tachometer) correspond to the other two first reflecting mirrors 250b. In FIG. 8, video light of video G2 at the center is indicated by dashed lines, and each video light of the other two videos G1 and G3 is indicated by dash-dotted lines. Since first reflecting mirror 250b in the middle is located in a different position from those of the other two first reflecting mirrors 250b, the viewing distance of the second virtual image formed by video G2 is different from the viewing distance of the second virtual images formed by videos G1 and G3. More specifically, the viewing distance of the second virtual image formed by video G2 is longer than the viewing distance of the second virtual images formed by videos G1 and G3. Stated differently, in the eyes of the driver, the second virtual image formed by video G2 appears to be present further than the second virtual images formed by videos G1 and G3. As described above, since the second virtual images are displayed in a plurality of layers in the eyes of the driver, it is possible for second display device 200B to provide diverse content displays.

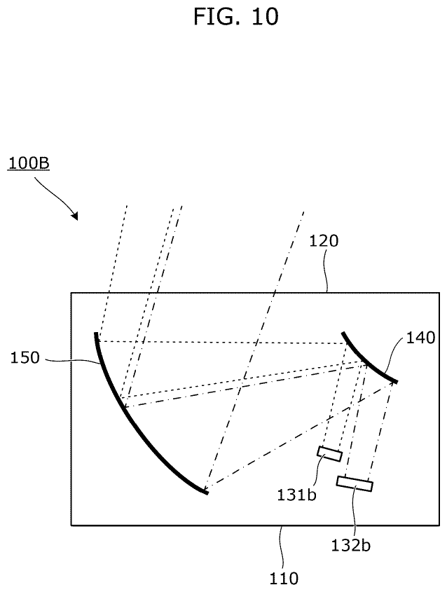

Note that first virtual images may be displayed in a plurality of layers also in the first display device. FIG. 10 is a schematic diagram showing first display device 100B according to Embodiment 3. As shown in FIG. 10, first display device 100B includes a plurality of (e.g., two) display elements 131b and 132b. Display element 131b is located closer to first optical element 140 than display element 132b is. For this reason, the viewing distance of the first virtual image formed by display element 131b is shorter than the viewing distance of the first virtual image formed by display element 132b. As a result, the first virtual image formed by display element 131b and the first virtual image formed by display element 132b are displayed in a plurality of layers in the eyes of the driver.

### Embodiment 4

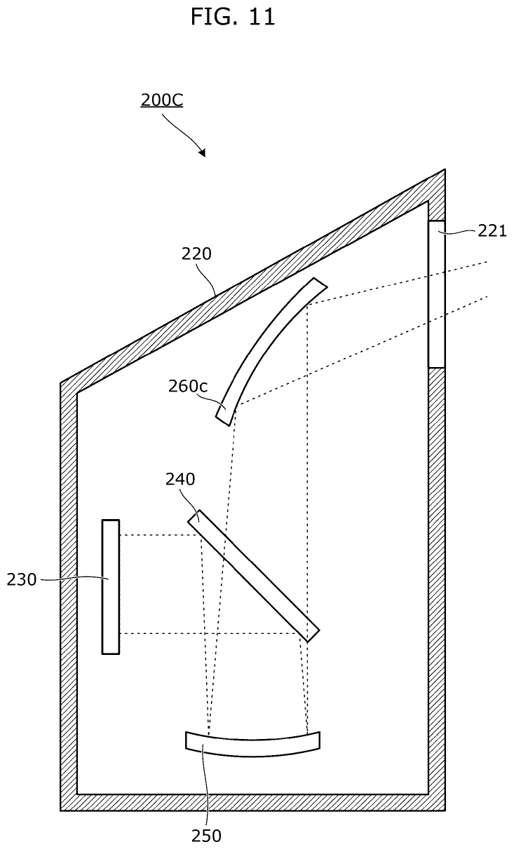

The following describes Embodiment 4. FIG. 11 is a schematic diagram showing second display device 200C according to Embodiment 4. As shown in FIG. 11, second reflecting mirror 260c of second display device 200C is a concave mirror. As described above, of the optical systems included in second display device 200C, second reflecting mirror 260c that reflects the video light at the final stage is a concave mirror. With this, the second virtual image is formed by means of the concave mirror reflecting and converging the video light at the final stage, thus easily securing the viewing distance of the second virtual image.

### Embodiment 5

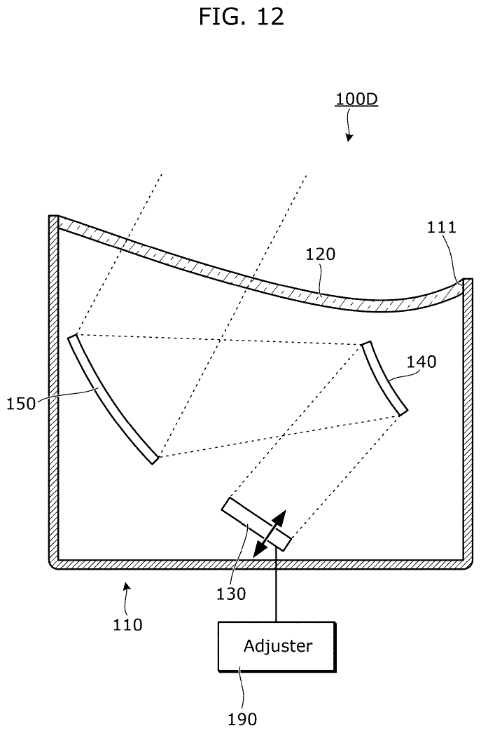

The following describes Embodiment 5. FIG. 12 is a schematic diagram showing first display device 100D according to Embodiment 5. As shown in FIG. 12, first display device 100D includes adjuster 190 for adjusting the viewing distance of first virtual image 101. Adjuster 190 is a device for moving display element 130 in the optical axis direction (normal direction of the display surface of display element 130). Adjuster 190 includes, for example, a moving mechanism for moving display element 130 back and forth in the optical axis direction, on the basis of a driving source and power from such driving source. Stated differently, adjuster 190 adjusts the position of display element 130 with respect to the optical axis direction, thereby adjusting the viewing distance of first virtual image 101.

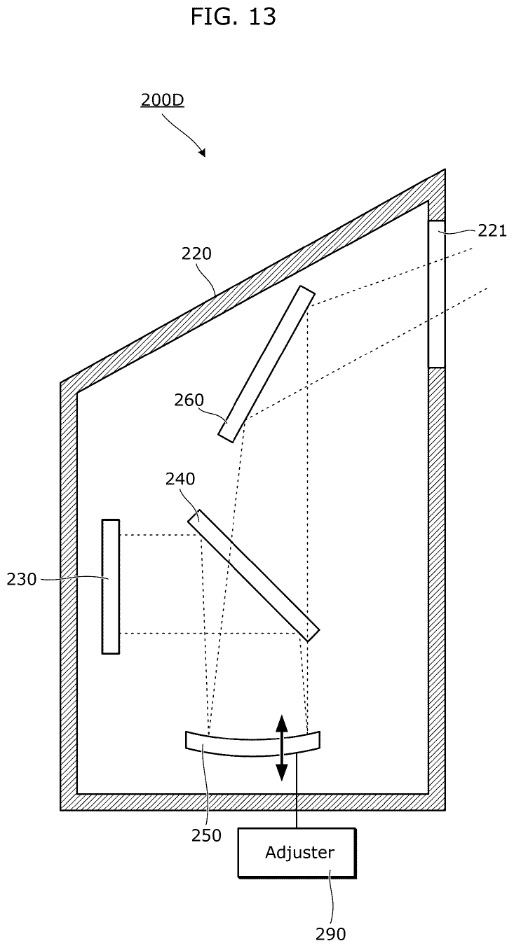

FIG. 13 is a schematic diagram showing second display device 200D according to Embodiment 5. As shown in FIG. 13, second display device 200D includes adjuster 290 for adjusting the viewing distance of second virtual image 201. Adjuster 290 is a device for moving first reflecting mirror 250 in the optical axis direction of the video light to be reflected. Adjuster 290 includes, for example, a moving mechanism for moving first reflecting mirror 250 back and forth in the optical axis, on the basis of a driving source and power from such driving source. Stated differently, adjuster 290 adjusts the position of first reflecting mirror 250 with respect to the optical axis direction, thereby adjusting the viewing distance of second virtual image 201.

As described above, since adjusters 190 and 290 are provided in first display device 100D and second display device 200D, respectively, it is possible to adjust the viewing distances of first virtual image 101 and second virtual image 201. With this, it is possible to adjust the viewing distances of first virtual image 101 and second virtual image 201 by means of adjusters 190 and 290, in accordance with various conditions. This enables more diverse content representation. Note that it suffices if adjuster 190 and adjuster 290 are provided in at least one of first display device 100D or second display device 200D.

### Embodiment 6

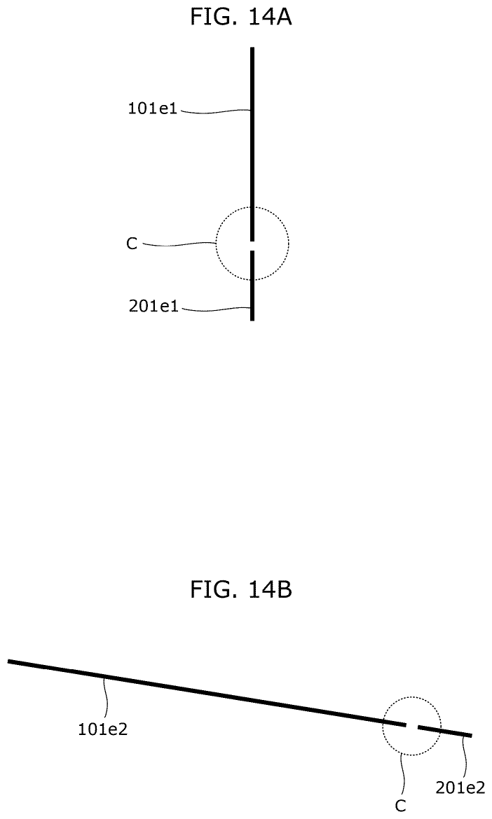

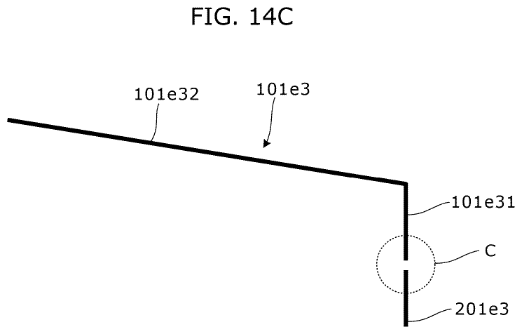

The following describes Embodiment 6. Embodiment 1 has described an example case where first virtual image 101 is located at an angle relative to the horizontal plane of vehicle 1, and second virtual image 201 is located parallel to the up-down direction of vehicle 1, as shown in FIG. 1. Embodiment 6 describes other examples of the layout of the first virtual image and the second virtual image. FIGS. 14A to 14C are explanatory diagrams showing examples of the layout of the first virtual image and the second virtual image according to Embodiment 6.

In Example Layout 1 shown in FIG. 14A, first virtual image 101e1 and second virtual image 201e1 are both located parallel to the up-down direction of vehicle 1 and are flush with each other. In this case, too, the lower end of first virtual image 101e1 and the upper end of second virtual image 201e1 are located within circle C.

In Example Layout 2 shown in FIG. 14B, first virtual image 101e2 and second virtual image 201e2 are both located at an angle relative to the horizontal plane of vehicle 1 such that the upper ends are located above the lower ends. Furthermore, first virtual image 101e2 and second virtual image 201e2 are located flush with each other. In this case, too, the lower end of first virtual image 101e2 and the upper end of second virtual image 201e2 are located within circle C.

In Example Layout 3 shown in FIG. 14C, first virtual image 101e3 is located at an angle relative to the horizontal plane of vehicle 1 such that first portion 101e31, which is the lower end portion, is parallel to the up-down direction of vehicle 1, and second portion 101e32, which is located above such first portion 101e31, is located upward, toward the front of vehicle 1. Second virtual image 201e3 is located to be parallel to the vertical plane of vehicle 1 and flush with first portion 101e31 of first virtual image 101e3. In this case, too, the lower end of first virtual image 101e3 and the upper end of second virtual image 201e3 are located within circle C.

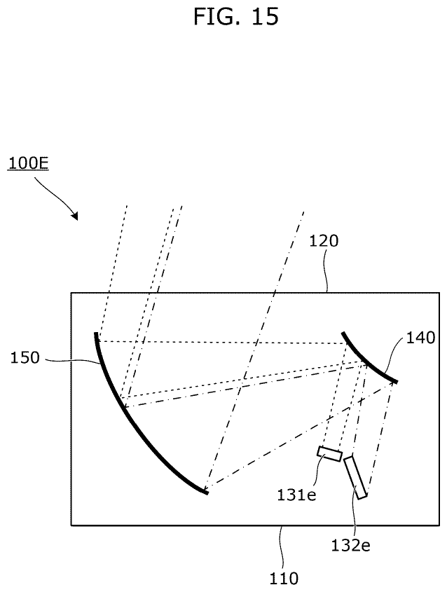

FIG. 15 is a schematic diagram showing first display device 100E corresponding to Example Layout 3 of Embodiment 6. As shown in FIG. 15, first display device 100E includes a plurality of (e.g., two) display elements 131e and 132e. Display elements 131e and 132e are disposed to be in mutually different orientations. Display element 131e forms first portion 101e31 of first virtual image 101e3, and display element 132e forms second portion 101e32 of first virtual image 101e3.

As described above, it is possible, in all of the example layouts, to reduce each of the gap in the up-down direction and the gap in the horizontal direction between the lower end of the first virtual image and the upper end of the second virtual image. This alleviates the burden on the driver caused by moving his/her viewpoint and focus point, switching between the first virtual image and the second virtual image, in viewing these virtual images.

### Embodiment 7

The following describes Embodiment 7. Embodiment 1 has described an example case where each of first display device 100 and second display device 200 includes a reflective optical system. However, at least one of the first display device or the second display device may include an optical system that includes hologram elements. Embodiment 7 describes the case where the first display device includes an optical system which includes hologram elements.

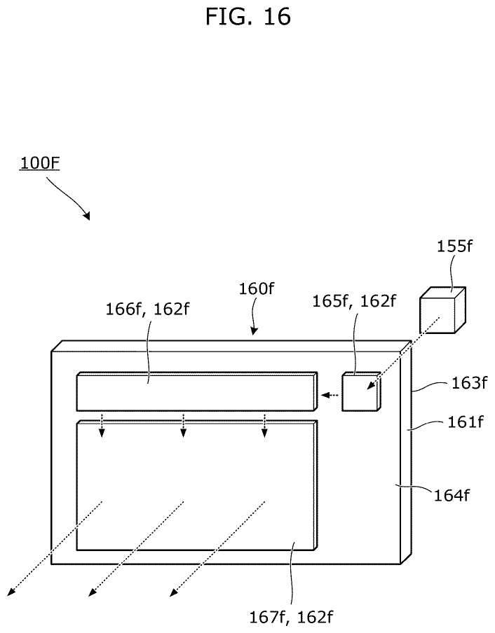

FIG. 16 is a schematic diagram showing first display device 100F according to Embodiment 7. As shown in FIG. 16, first display device 100F includes image generating device 155f and light guide body 160f.

Image generating device 155f is a device that outputs video light to light guide body 160f. Light guide body 160f is an optical system that includes hologram elements, and is a hologram light guide body in the present embodiment. Light guide body 160f, which has light-transmissivity, enlarges the video light outputted by image generating device 155f and outputs the enlarged video light toward windshield 2. Light guide body 160f includes light guide 161f having light-transmissivity, and a plurality of hologram elements 162f.

Light guide 161f includes input surface 163f facing image generating device 155f and output surface 164f facing windshield 2. Light guide 161f is configured using a material having light-transmissivity such as glass and a resin material.

Light guide 161f internally includes the plurality of hologram elements 162f. The plurality of hologram elements 162f are light-transmissive optical elements that diffract light propagating inside light guide 161f and outputs the diffracted light. The plurality of hologram elements 162f are internally included in light guide 161f in an orientation that is approximately parallel to the input surface and the output surface of light guide 161f. The plurality of hologram elements 162f are configured using a material having light-transmissivity. The plurality of hologram elements 162f include first hologram element 165f, second hologram element 166f, and third hologram element 167f.

First hologram element 165f is an input hologram element where the video light outputted by image generating device 155f enters. First hologram element 165f outputs the video light that has entered first hologram element 165f toward second hologram element 166f. More specifically, first hologram element 165f deflects the video light by diffraction in accordance with the diffraction efficiency of first hologram element 165f and outputs the deflected video light toward second hologram element 166f.

Second hologram element 166f is a folding hologram element that diffracts the video light from first hologram element 165f and outputs the diffracted video light toward third hologram element 167f. More specifically, second hologram element 166f deflects the video light by diffraction in accordance with the diffraction efficiency of second hologram element 166f and outputs the deflected video light toward third hologram element 167f.

Third hologram element 167f diffracts the video light from second hologram element 166f and outputs, from output surface 164f, the diffracted video light to outside of light guide body 160f. More specifically, third hologram element 167f deflects the video light by diffraction in accordance with the diffraction efficiency of third hologram element 167f and outputs the deflected video light to outside from output surface 164f.

As described above, since first display device 100F includes an optical system (light guide body 160f) that includes the hologram elements, it is possible for first display device 100F to have a low-profile optical system.

### Embodiment 8

The following describes Embodiment 8. Embodiment 1 has shown an example case where a first display position of first virtual image 101 and a second display position of second virtual image 201 are not changeable. However, the first display position of the first virtual image and the second display position of the second virtual image may be changeable.

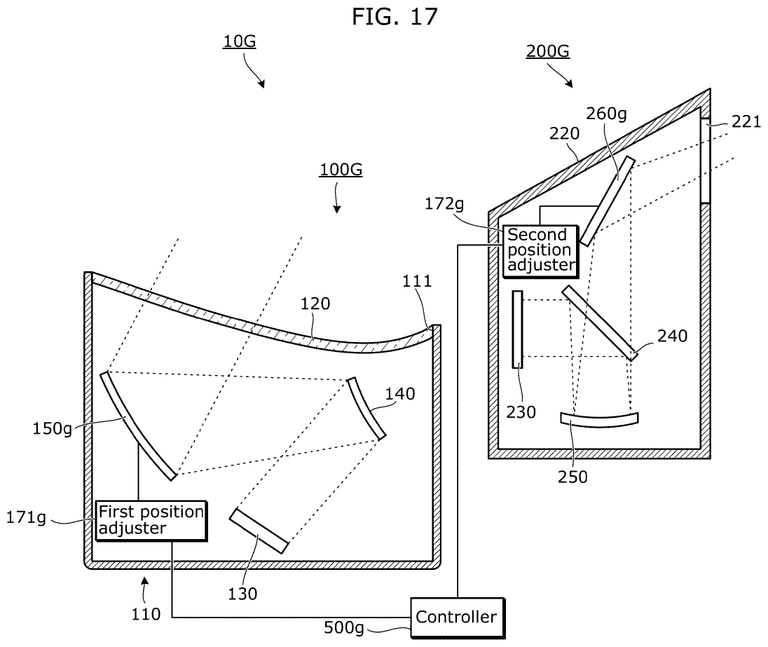

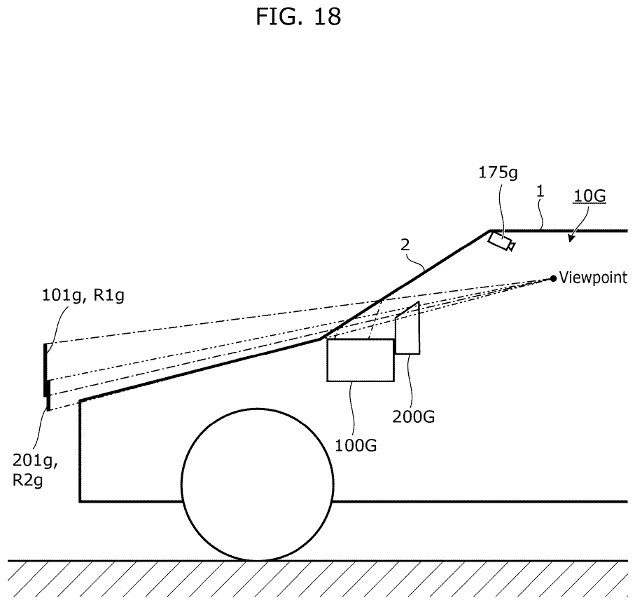

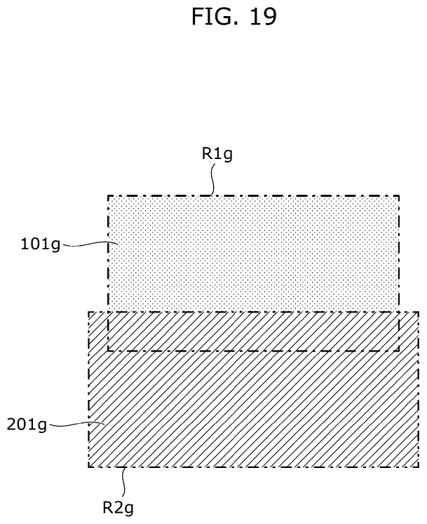

FIG. 17 is a schematic diagram showing display system 10G according to Embodiment 8. FIG. 18 is an explanatory diagram showing first virtual image 101g and second virtual image 201g in the reference positions in display system 10G according to Embodiment 8. Note that, in a strict sense, FIG. 18 shows displayable range R1g of first virtual image 101g and displayable range R2g of second virtual image 201g. The displayable ranges are regions where virtual images are displayable.

As shown in FIG. 17, display system 10G includes first position adjuster 171g and second position adjuster 172g, which are electrically connected to and controlled by controller 500g.

First position adjuster 171g is provided in housing 110 of first display device 100G and adjusts the first display position in the up-down direction of first virtual image 101g. More specifically, first position adjuster 171g includes a rotation mechanism for adjusting the orientation (tilt) of second optical element 150g and a drive motor for driving such rotation mechanism. Second optical element 150g is an example of the first reflector that reflects the video light forming first virtual image 101g. Second optical element 150g rotates clockwise or counterclockwise, with the center of its reflecting surface, for example, serving as the center of rotation. This movement is caused by the rotation mechanism and the drive motor included in first position adjuster 171g. This causes the orientation of second optical element 150g to change. In response to the change in the orientation of second optical element 150g, the optical path of the video light forming first virtual image 101g also moves. As a result, the first display position of first virtual image 101g is adjusted.

Second position adjuster 172g is provided in housing 220 of second display device 200G and adjusts the second display position in the up-down direction of second virtual image 102g. More specifically, second position adjuster 172g includes a rotation mechanism for adjusting the orientation (tilt) of second reflecting mirror 260g and a drive motor for driving such rotation mechanism. Second reflecting mirror 260g is an example of the second reflector that reflects the video light forming second virtual image 201g. Second reflecting mirror 260g rotates clockwise or counterclockwise, with the center of its reflecting surface, for example, serving as the center of rotation. This movement is caused by the rotation mechanism and the drive motor included in second position adjuster 172g. This causes the orientation of second reflecting mirror 260g to change. In response to the change in the orientation of second reflecting mirror 260g, the optical path of the video light forming second virtual image 201g also moves. As a result, the second display position of second virtual image 201g is adjusted.

Further, as shown in FIG. 18, display system 10G includes head imager 175g for imaging the head of the driver. Head imager 175g is a camera disposed in the vicinity of the upper portion of windshield 2 in vehicle 1, and captures an image of the vehicle interior. Head imager 175g is connected to controller 500g, and outputs the captured image to controller 500g. Controller 500g detects the head position of the driver from the image captured by head imager 175g, and estimates the viewpoint position of the driver, on the basis of such detected head position. Stated differently, controller 500g is an example of the estimator that estimates the viewpoint position of the driver, on the basis of the image captured by head imager 175g.

Controller 500g controls first position adjuster 171g and second position adjuster 172g, on the basis of the estimated viewpoint position of the driver. As is known from the above, controller 500g is an example of the adjustment controller. Through this control, it is possible to adjust the first display position and the second display position to positions that are responsive to the viewpoint position of the driver.

Subsequently, controller 500g changes the coordinates of first virtual image 101g within displayable range R1g of first virtual image 101g, on the basis of the first display position and the second display position that have been adjusted. With this, it possible to display first virtual image 101g and second virtual image 201g for the driver to have a lesser sense of discomfort.

The following specifically describes the difference between first virtual image 101g and second virtual image 201g before and after adjusting the first display position and the second display position.

FIG. 19 is an explanatory diagram showing first virtual image 101g and second virtual image 201g in the reference positions seen from the driver in Embodiment 8. As shown in FIG. 19, displayable range R1g of first virtual image 101g is indicated by single dash-dotted lines, and displayable range R2g of second virtual image 201g is indicated by double dash-dotted lines. First virtual image 101g is represented as the dot-hatched region within displayable range R1g. Second virtual image 201g is represented as the hatched region within displayable range R2g. Second virtual image 201g is located across the entirety of displayable range R2g. The lower end portion of displayable range R1g overlaps displayable range R2g, and first virtual image 101g is not displayed in such overlapping portion. Stated differently, first virtual image 101g and second virtual image 201g are displayed without any gaps in the up-down direction. With this, first virtual image 101g and second virtual image 201g appear to be integrated in the eyes of the driver, thus enabling the driver to be less likely to feel a sense of discomfort.

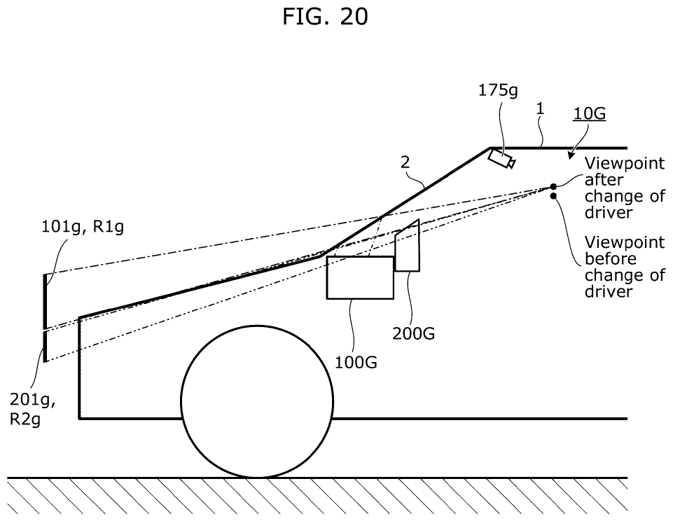

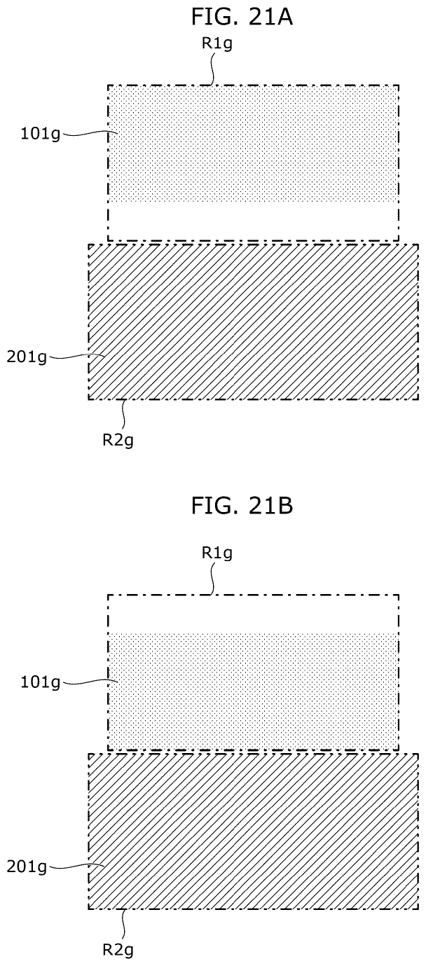

Next, the case is assumed where a large driver takes over driving. FIG. 20 is an explanatory diagram showing a state in which a large driver takes over driving, and the first display position and the second display position have been adjusted in Embodiment 8. FIG. 20 corresponds to FIG. 18.

As shown in FIG. 20, since a large driver has taken over driving, the viewpoint position also moves upward (from “viewpoint before change of driver” to “viewpoint after change of driver” in FIG. 20). Controller 500g detects the head position of the driver, on the basis of the image captured by head imager 175g, and estimates the viewpoint position of the driver, on the basis of such detected head position. After that, controller 500g controls first position adjuster 171g and second position adjuster 172g, on the basis of the estimated viewpoint position of the driver. Through this, the first display position and the second display position are adjusted to positions that are responsive to the viewpoint position of the driver. In the present embodiment, the first display position is moved upward without moving the second display position. As a result, displayable range R1g is moved up to a position at which displayable range R1g does not overlap displayable range R2g. At this time, the smaller the better the gap between the lower end of displayable range R1g and the upper end of displayable range R2g.

FIG. 21A is an explanatory diagram showing first virtual image 101g and second virtual image 201g only after the first display position has been adjusted in Embodiment 8. FIG. 21A corresponds to FIG. 19. As shown in FIG. 21A, the mere movement of the first display position upward results in the coordinates of first virtual image 101g within displayable range R1g remaining constant. As a result, a gap occurs between first virtual image 101g and second virtual image 201g.

For this reason, controller 500g changes the coordinates of first virtual image 101g within displayable range R1g of first virtual image 101g, on the basis of the first display position and the second display position that have been adjusted. More specifically, controller 500g causes first virtual image 101g to be displayed at coordinates, within displayable range R1g, that are closer to displayable range R2g than before the coordinates are changed. More preferably, controller 500g causes first virtual image 101g to be displayed at coordinates at which the lower end of first virtual image 101g overlaps the lower end of displayable range R1g.

FIG. 21B is an explanatory diagram showing first virtual image 101g and second virtual image 201g in the case where the first display position has been adjusted and the coordinates of first virtual image 101g have been adjusted in Embodiment 8. FIG. 21B corresponds to FIG. 21A. As shown in FIG. 21B, since the coordinates of first virtual image 101g within displayable range R1g have been adjusted as described above, the gap between first virtual image 101g and second virtual image 201g has been reduced. With this, first virtual image 101g and second virtual image 201g appear to be integrated in the eyes of the driver, thus enabling the driver to be less likely to feel a sense of discomfort.

As described above, display system 10G includes controller 500g, which is the coordinate changer, and first position adjuster 171g and second position adjuster 172g. With this, even when the viewpoint position of the driver has changed, it is possible to adjust the coordinates of first virtual image 101g within displayable range R1g, while adjusting the first display position of first virtual image 101g and the second display position of second virtual image 201g. This enables first virtual image 101g and second virtual image 201g to be suitably displayed also for a different driver.

Further, since first position adjuster 171g adjusts the first display position of first virtual image 101 by adjusting the orientation (tilt) of second optical element 150g, it is possible to adjust the first display position using a simple structure. Meanwhile, since second position adjuster 172g adjusts the second display position of second virtual image 201g by adjusting the orientation (tilt) of second reflecting mirror 260g, it is possible to adjust the second display position using a simple structure. These enable first virtual image 101g and second virtual image 201g to be suitably displayed also for a different driver.

Further, controller 500g estimates the viewpoint position of the driver, on the basis of the image captured by head imager 175g, and controls first position adjuster 171g and second position adjuster 172g, on the basis of such estimated viewpoint position. This enables the first display position and the second display position to be automatically adjusted.

Note that the present embodiment has described an example case where first position adjuster 171g adjusts the first display position by adjusting the orientation of second optical element 150g. However, first position adjuster 171g may adjust the first display position by adjusting the position of second optical element 150g. Further, when the first display position is adjustable, first position adjuster 171g may adjust at least one of the orientation or the position of another optical element (display element 130, first optical element 140, etc.), or may adjust the orientation and the position of the entirety of first display device 100G. The same applies to second position adjuster 172g.

The present embodiment has also described an example case where controller 500g automatically adjusts the first display position and second display position, but these adjustments may also be manually made. More specifically, display system 10G may include a control unit for inputting operation instructions to be provided to first position adjuster 171g and second position adjuster 172g. When the user operates the control unit to adjust the first display position and the second display position, for example, controller 500g controls first display device 100G and second display device 200G to cause them to display first virtual image 101g and second virtual image 201g for testing. Furthermore, when the user inputs an operation instruction to the control unit for moving the first display position and second display position, controller 500g causes first position adjuster 171g and second position adjuster 172g to operate, on the basis of such operation instruction. With this, it is possible to adjust the first display position and the second display position to the positions intended by the user. In this case, too, controller 500g changes the coordinates of first virtual image 101g within displayable range R1g of first virtual image 101g, on the basis of the first display position and the second display position that have been adjusted.

### Embodiment 9

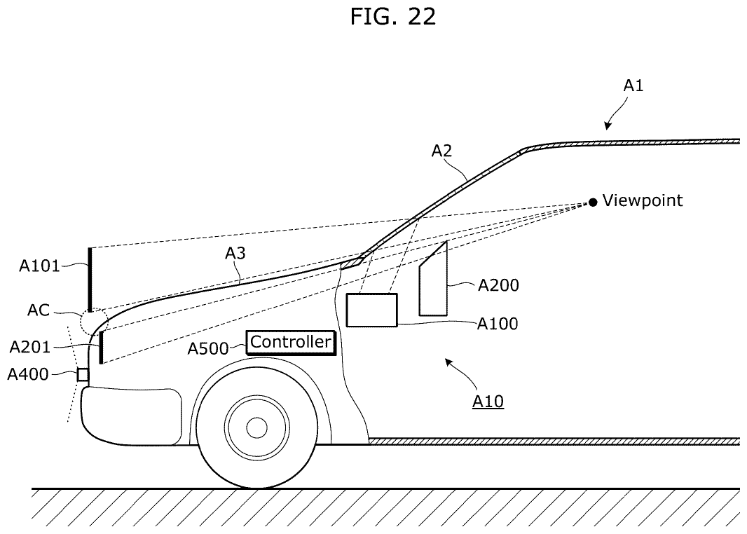

FIG. 22 is a schematic diagram showing display system A10 according to Embodiment 9 disposed in vehicle A1. In FIG. 22, vehicle A1 is shown in cross-section. Here, the user of display system A10 is the driver in vehicle A1.

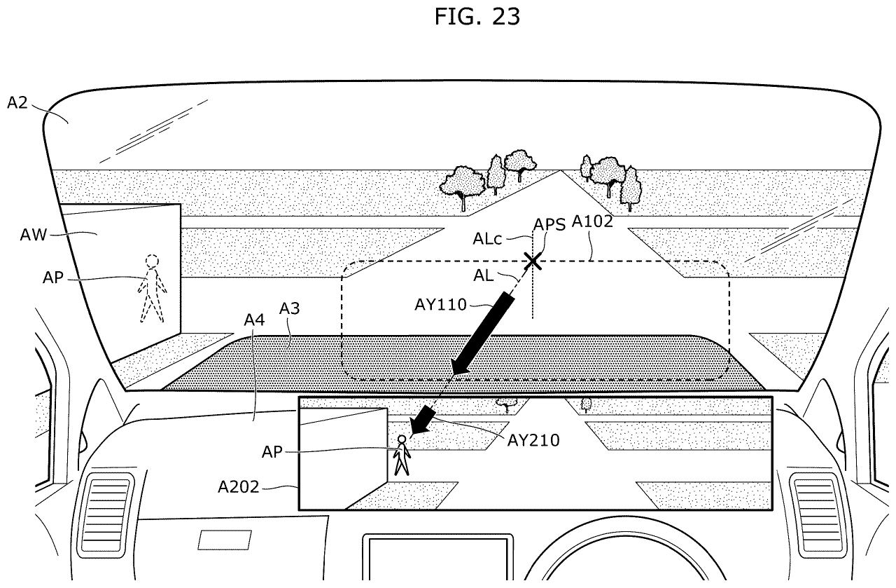

As shown in FIG. 22, display system A10 includes first display device A100, second display device A200, first imager A400, and controller A500. First display device A100 and second display device A200 are disposed, for example, inside dashboard A4 of vehicle A1 (see FIG. 23). First display device A100 and second display device A200 display, for example, vehicle information related to vehicle A1 as first virtual image A101 and second virtual image A201. Examples of the vehicle information include the vehicle speed of vehicle A1, the number of revolutions of the engine, a detection result on an object that is present in the proximity of vehicle A1, navigation information from the current position of vehicle A1 to the destination, image information captured by a camera that captures an image of the rear of vehicle A1, notification information to be provided to the driver, etc. The notification information is information indicating that target object AP (see FIG. 23) is present in the image captured by first imager A400. Target object AP is, for example, a moving object (pedestrian, animal, vehicle other than vehicle A1 such as automobile, motorcycle, kickboard, etc.) that is present in the surroundings of vehicle A1. Stated differently, the notification information is information for notifying the driver of vehicle A1 of that a moving object is present in the proximity of vehicle A1.

Note that FIG. 22 shows an example case where first display device A100 and second display device A200 are disposed inside dashboard A4, but the position where first display device A100 and second display device A200 are disposed is not limited to this; first display device A100 may be disposed, for example, in the vicinity of the upper end of windshield A2 and second display device A200 may be disposed, for example, in the center console.

First display device A100 is a transmissive display such as an augmented reality head-up display (AR-HUD). First display device A100 projects light onto windshield (windscreen) A2 serving as a display medium. The projected light is reflected by windshield A2. Such reflected light travels toward the eyes of the driver, who is seated in the driver's seat. The driver perceives the reflected light that has entered his/her eyes as first virtual image A101 that is seen on the opposite side across windshield A2 (outside the vehicle), against the actual objects seen across windshield A2 serving the background. FIG. 22 shows an example of the position of first virtual image A101 seen from the viewpoint of the driver. It is possible to set this position by adjusting the imaging position of the video light outputted from first display device A100. The viewpoint of the driver is, for example, the reference eyepoint. The reference eyepoint is “the point that represents the position of the eyes of the driver under normal driving conditions”.

Second display device A200 is a non-transmissive display. Second display device A200 projects the video light toward the driver. The driver perceives the video light that has entered his/her eyes as second virtual image A201 that appears in a distant position from second display device A200. Stated differently, the video light outputted from second display device A200 travels toward the eyes of the driver seated in the driver's seat to be second virtual image A201. FIG. 22 shows an example of the position of second virtual image A201 seen from the viewpoint of the driver. Note that second display device A200 may be a transmissive display such as a head-up display (HUD).

The following describes the positional relationship between first virtual image A101 and second virtual image A201. As shown in FIG. 22, first virtual image A101 is formed to be parallel to the vertical plane in a side view of vehicle A1.

Second virtual image A201 is located below first virtual image A101 in a side view of vehicle A1. Second virtual image A201 is formed to be parallel to the vertical plane. The lower end of first virtual image A101 and the upper end of second virtual image A201 are located in proximity to each other. More specifically, the lower end of first virtual image A101 and the upper end of second virtual image A201 are located within circle AC whose diameter is the length of second virtual image A201 in a side view. The length of second virtual image A201 is the entire length of second virtual image A201 in a side view. In the present embodiment, since second virtual image A201 is located parallel to the vertical plane, the length of second virtual image A201 is the length in the vertical direction (up-down direction).

As described above, since the lower end of first virtual image A101 and the upper end of second virtual image A201 are located in proximity to each other, it is possible to reduce each of the gap in the up-down direction and the gap in the horizontal direction between the lower end of first virtual image A101 and the upper end of second virtual image A201.

First imager A400 is a camera that captures images of the surroundings of vehicle A1. More specifically, first imager A400 captures images of an area ahead of vehicle A1. First imager A400 is disposed more forward than the driver is who is seated in the driver's seat. More specifically, first imager A400 is disposed at the front-end portion of vehicle A1. This enables first imager A400 to image target object AP that is in a blind spot of the driver.

Controller A500 is disposed inside dashboard A4 and controls first display device A100, second display device A200, and first imager A400. Since a single controller A500 controls first display device A100, second display device A200, and first imager A400, it is possible to simplify the control structure of the entire system and also reduce power consumption.

More specifically, controller A500 includes a CPU, a RAM, a ROM, etc., and each process is executed by the CPU loading, in the RAM, a program stored in the ROM and executing such program. For example, controller A500 performs image processing on image data captured by first imager A400 to recognize at least one target object AP included in such image data, and detects the position coordinates, the size, etc. of such target object AP. Controller A500 further performs image processing on the image data to recognize a structure (building, wall, etc.) included in such image data, and detects the position coordinates, the size, etc. of the structure. Controller A500 extracts target object AP that is in a blind spot due to the structure when seen from the viewpoint of the driver (reference eyepoint), and generates notification information AY110 and AY210 (see FIG. 23), on the basis of, for example, the position coordinates and the size of such extracted target object AP. Controller A500 then causes first display device A100 and second display device A200 to display the notification information.

### Example Display

The following describes an example of displaying notification information AY110 and AY210. FIG. 23 is an explanatory diagram showing an example of displaying notification information AY110 and AY210 according to Embodiment 9. In the example display shown in FIG. 23, the upper half of first display area A102 of first virtual image A101 displayed by first display device A100 mostly overlaps windshield A2, and the remaining part overlaps hood A3 of vehicle A1. Second display area A202 of second virtual image A201 displayed by second display device A200 overlaps dashboard A4.

Controller A500 controls first display device A100 to cause it to display notification information AY110 in the form of an arrow as first virtual image A101 within first display area A102. Meanwhile, controller A500 controls second display device A200 to cause it to display the video captured by first imager A400 as second virtual image A201 across the entirety of second display area A202, and also to display notification information AY210 in the form of an arrow as second virtual image A201 within second display area A202. Stated differently, in second display area A202, notification information AY210 is displayed on the video captured by first imager A400 in an overlaid manner. Here, the video captured by first imager A400 is an example of the vehicle surrounding information. The vehicle surrounding information is information indicating the situation around vehicle A1. In the present embodiment, the vehicle surrounding information is video, captured by first imager A400, of an area ahead of vehicle A1. Note that the vehicle surrounding information may be an image for navigation that is synchronized with the video captured by first imager A400, or may be a combination of the video and the image for navigation. When causing first display device A100 and second display device A200 to display notification information AY110 and AY210, controller A500 causes first display device A100 and second display device A200 to display notification information AY110 and AY210 after adjusting at least one of the luminance, the size, or the chromaticity of each of notification information AY110 and AY210, and to display notification information AY110 and AY210 together with the vehicle surrounding information obtained from first imager A400. Details of these adjustments are described later.

Notification information AY110 and AY210 are graphics for guiding the line of sight of the driver to target object AP. The present embodiment shows an example case where notification information AY110 and AY210 are arrows, but notification information AY110 and AY210 may also be other graphics. To increase the effect of guiding the line of sight of the driver, it suffices if notification information AY110 and AY210 are displayed at least for a certain length of time (e.g., 0.2 seconds or longer). Notification information AY110 and AY210 may alternately flash. In the case where notification information AY110 and AY210 flash, the flashing cycle is, for example, between 0.5 seconds and 1 second, inclusive. The flashing cycle may be different for alerting and for warning. For example, the flashing cycle for warning that is shorter than the flashing cycle for alerting can express a sense of caution. In addition, one of notification information AY110 and AY210 may be kept lit while the other is flashing.

Target object AP is in a blind spot due to wall AW and thus invisible from the viewpoint of the driver. However, since first imager A400 is capturing an image of such target object AP, target object AP appears in the video captured by first imager A400. Controller A500 extracts target object AP that is in the blind spot and causes notification information AY110 and AY210 to be displayed on straight line AL that connects the coordinate position of target object AP and display reference point APS. Straight line AL is a virtual straight line that is set spanning first display area A102 and second display area A202. Although not displayed in first display area A102 and second display area A202 in FIG. 23, straight line AL may be displayed.

Since the present embodiment shows the case where target object AP is present outside first display area A102, display reference point APS is set on center line ALc in the width direction of first display area A102 (width direction of the vehicle). Display reference point APS may be located either inside or outside first display area A102. Furthermore, display reference point APS may be located at the vanishing point seen from the driver. In this case, the driver is more likely to notice notification information AY110 when looking ahead.

### [Luminance Adjustment]

When causing first display device A100 and second display device A200 to display notification information AY110 and AY210, controller A500 may adjust the luminance of each of notification information AY110 and AY210 between first display device A100 and second display device A200, on the basis of the vehicle surrounding information.

More specifically, controller A500 calculates the luminance of the background from the video, captured by first imager A400, of an area ahead of vehicle A1 (vehicle surrounding information). Controller A500 calculates the luminance of first virtual image A101 in a state of being overlaid on the background, on the basis of the luminance of such background. Stated differently, when the luminance of the background is high, such as during the daytime, controller A500 calculates the luminance of first virtual image A101, especially the luminance of notification information AY110 in first virtual image A101, such that the luminance is at or higher than the level at which the driver can view notification information AY110. Conversely, when the luminance of the background is low, such as at night time, controller A500 calculates the luminance of first virtual image A101, especially the luminance of notification information AY110 in first virtual image A101, such that the luminance is low to a degree at which the driver will not suffer glare. Controller A500 adjusts the luminance of each of notification information AY110 and AY210 between first display device A100 and second display device A200, on the basis of the calculation result.

For example, controller A500 may adjust the luminance of each of notification information AY110 and AY210 between first display device A100 and second display device A200 to cause the luminance of notification information AY110 in first virtual image A101 and the luminance of notification information AY210 in second virtual image A201 to be approximately the same. With this, it is possible to reduce the difference in the luminance between notification information AY110 in first virtual image A101 and notification information AY210 in second virtual image A201. This further reduces the user's sense of discomfort that occurs when the user views notification information AY110 in first virtual image A101 and notification information AY210 in second virtual image A201. It suffices if the difference in the luminance of notification information AY110 from the luminance of notification information AY210 is 20% or less, and more preferably 10% or less.

Controller A500 may also adjust the luminance of each of notification information AY110 and AY210 between first display device A100 and second display device A200 to cause the luminance of notification information AY110 in first virtual image A101 to be higher than the luminance of notification information AY210 in second virtual image A201. With this, since the luminance of notification information AY110 in first virtual image A101 is adjusted to be higher than the luminance of notification information AY210 in second virtual image A201, it is possible to make notification information AY110 in first virtual image A101, which is located above second virtual image A201, more stand out. This enables the driver to more easily recognize notification information AY110 in first virtual image A101. The difference in the luminance of notification information AY110 from the luminance of notification information AY210 is preferably 20% or higher.

Controller A500 may also adjust the luminance of each of notification information AY110 and AY210 between first display device A100 and second display device A200 to cause the luminance of notification information AY110 in first virtual image A101 to be lower than the luminance of notification information AY210 in second virtual image A201. With this, since the luminance of notification information AY110 in first virtual image A101 is adjusted to be lower than the luminance of notification information AY210 in second virtual image A201, it is possible to make notification information AY210 in second virtual image A201, which is displayed below first virtual image A101 and thus directs the line of sight of the driver downward, more stand out. The difference in the luminance of notification information AY110 from the luminance of notification information AY210 is preferably 20% or higher.

Note that when the upper limit of the luminance of first display device A100 is preliminarily set by the user, it is preferable that controller A500 adjusts the luminance of notification information AY110 such that such luminance of first display device A100 does not exceed the upper limit of the luminance.

### [Size Adjustment]

Controller A500 may adjust the size of each of notification information AY110 and AY210 between first display device A100 and second display device A200. More specifically, controller A500 adjusts the width of each of notification information AY110 and AY210 between first display device A100 and second display device A200 to cause the width of the arrow representing notification information AY110 and the width of the arrow representing notification information AY210 shown in FIG. 23 to be approximately the same. The difference in the width of notification information AY110 from the width of notification information AY210 is preferably is 10% or less.

### [Chromaticity Adjustment]

When causing first display device A100 and second display device A200 to display notification information AY110 and AY210, controller A500 may adjust the chromaticity of each of notification information AY110 and AY210 between first display device A100 and second display device A200, on the basis of the vehicle surrounding information.

More specifically, controller A500 calculates the chromaticity of the background from the video, captured by first imager A400, of an area ahead of vehicle A1 (vehicle surrounding information). Controller A500 calculates the chromaticity of first virtual image A101 in a state of being overlaid on the background, on the basis of the chromaticity of such background. Controller A500 adjusts the chromaticity between first display device A100 and second display device A200 to cause the chromaticity of notification information AY110 in first virtual image A101 to be approximately the same as the chromaticity of notification information AY210 in second virtual image A201, on the basis of the calculation result. When the color of the background is mainly green, as in the case where the vehicle is traveling through a mountainous area, for example, notification information AY110 colored green will not stand out. For this reason, it suffices if the chromaticity of notification information AY110 is adjusted such that notification information AY110 appears red, which is the complementary color of green. To this end, by coloring notification information AY110 purple, it will be mixed with the green of the background, as a result of which notification information AY110 will appear red in the eyes of the driver, making it easier for the driver to recognize. When this is done, notification information AY210 of second display device A200 is simply required to be colored red. Here, the difference (color difference ΔE*) between the chromaticity of notification information AY110 and the chromaticity of notification information AY210 is preferably 6.5 or less, and more preferably 3.2 or less.

In addition, controller A500 may adjust the chromaticity of notification information AY110 in first virtual image A101, with the chromaticity of notification information AY210 in second virtual image A201 kept constant. This enables notification information AY110 to be more easily viewed in first virtual image A101.

In addition, controller A500 may adjust the chromaticity of notification information AY210 in second virtual image A201 to be approximately the same as the chromaticity of notification information AY110 in first virtual image A101, with the chromaticity of notification information AY110 in first virtual image A101 kept constant. This enables the chromaticity of notification information AY110 in first virtual image A101 to be less likely to change, thus alleviating the burden on the driver when looking ahead.

### Effects, Etc.

As described above, according to the present embodiment, when notification information AY110 and AY210 are displayed by first display device A100 and second display device A200, at least one of the luminance, the size, or the chromaticity of each of notification information AY110 and AY210 to be displayed together with the vehicle surrounding information obtained from first imager A400 is adjusted between first display device A100 and second display device A200. This enables notification information AY110 displayed by first display device A100 and notification information AY210 displayed by second display device A200 to be displayed in a visually uniform (consistent) manner. It is thus possible to reduce the driver's sense of discomfort that occurs when such driver views notification information AY110 in first virtual image A101 and notification information AY210 in second virtual image A201.

First display device A100 projects first virtual image A101 and second display device A200 projects second virtual image A201. As such, when the driver views notification information AY110 in first virtual image A101 and notification information AY210 in second virtual image A201, these virtual images are viewed at distant positions, thus reducing the driver's sense of discomfort.

The lower end of first virtual image A101 and the upper end of second virtual image A201 are located in proximity to each other. It is thus possible to reduce each of the gap in the up-down direction and the gap in the horizontal direction between the lower end of first virtual image A101 and the upper end of second virtual image A201. This alleviates the burden on the driver caused by moving his/her viewpoint and focus point when shifting the eyes from first virtual image A101 to second virtual image A201, or from second virtual image A201 to first virtual image A101.

The luminance of first virtual image A101 in a state of being overlaid on the background is calculated, on the basis of the vehicle surrounding information. Then, on the basis of the calculation result, the luminance of each of notification information AY110 and AY210 is adjusted between first display device A100 and second display device A200. With this, it is possible to reflect, on the luminance of each of notification information AY110 and AY210, the influence of the background exerted on the luminance of first virtual image A101. This enables information notification that creates a lesser sense of discomfort.

The luminance of notification information AY110 in first virtual image A101 and the luminance of notification information AY210 in second virtual image A201 are adjusted to be approximately the same. It is thus possible to reduce the difference in the luminance between notification information AY110 in first virtual image A101 and notification information AY210 in second virtual image A201. This further reduces the driver's sense of discomfort that occurs when such driver views notification information AY110 in first virtual image A101 and notification information AY210 in second virtual image A201.

The luminance of notification information AY110 in first virtual image A101 is adjusted to be higher than the luminance of notification information AY210 in second virtual image A201. It is thus possible to make notification information AY110 in first virtual image A101, which is located above second virtual image A201, more stand out. This enables the driver to more easily recognize notification information AY110 within first virtual image A101.

The luminance of notification information AY110 in first virtual image A101 is adjusted to be lower than the luminance of notification information AY210 in second virtual image A201. It is thus possible to make notification information AY210 in second virtual image A201, which is displayed below first virtual image A101 and thus directs the line of sight of the driver downward, more stand out.

The size of each of notification information AY110 and AY210 is adjusted between first display device A100 and second display device A200. It is thus possible to reduce a sense of discomfort attributable to the size of each of notification information AY110 and AY210 between first display device A100 and second display device A200.

The chromaticity of first virtual image A101 in a state of being overlaid on the background is calculated, on the basis of the vehicle surrounding information. Then, on the basis of the calculation result, the chromaticity of notification information AY110 in first virtual image A101 and the chromaticity of notification information AY210 in second virtual image A201 are adjusted to be approximately the same. With this, it is possible to adjust the chromaticity of notification information AY110 in first virtual image A101 and the chromaticity of notification information AY210 in second virtual image A201 to be approximately the same, in consideration of the influence of the background exerted on first virtual image A101. This enables information notification that creates a lesser sense of discomfort.

The chromaticity of notification information AY110 in first virtual image A101 is adjusted, with the chromaticity of notification information AY210 in second virtual image A201 kept constant. It enables notification information AY110 to be more easily viewed in first virtual image A101.

The chromaticity of notification information AY210 in second virtual image A201 is adjusted to be approximately the same as the chromaticity of notification information AY110 in first virtual image A101, with the chromaticity of notification information AY110 in first virtual image A101 kept constant. It is thus possible for the chromaticity of notification information AY110 in first virtual image A101 to be less likely to change. This alleviates the burden on the driver when looking ahead.

When target object AP is present outside first display area A102, notification information AY110 is displayed on display reference point APS, which is set on center line ALc in the width direction of first display area A102. Stated differently, since notification information AY110 is located on center line ALc of first display area A102, when target object AP is not present in first display area A102, it is possible for the driver to more reliably view notification information AY110.

Notification information AY110 displayed by first display device A100 and notification information AY210 displayed by second display device A200 are located on straight line AL that includes display reference point APS. It is thus possible for the driver to linearly move the line of sight to each of notification information AY110 and AY210. This alleviates the burden on the driver caused by moving the line of sight.

The video captured by first imager A400 is displayed by second display device A200. It is thus possible to display the video captured by first imager A400 and notification information AY210 displayed by second display device A200 in an overlaid manner. This enables notification information AY210 to be displayed on a clear video, thereby enabling content representation that is easy for the driver to understand.

### Embodiment 10

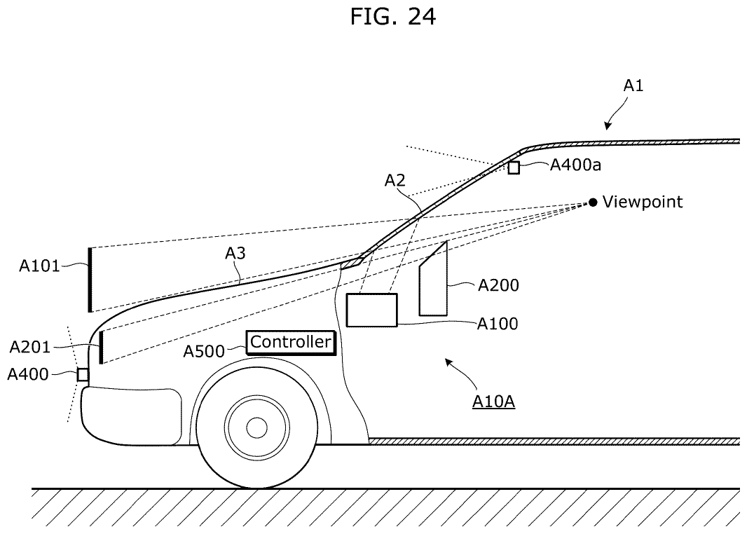

The following describes Embodiment 10. FIG. 24 is a schematic diagram showing display system A10A according to Embodiment 10. As shown in FIG. 24, display system A10A further includes first imager A400a that captures images of an area ahead of vehicle A1. First imager A400a is disposed in the vicinity of the upper end of windshield A2 inside vehicle A1, and captures images of the area ahead of vehicle A1 via windshield A2. Controller A500 calculates the luminance and the chromaticity of the background from the video, captured by first imager A400a, of an area ahead of vehicle A1 (vehicle surrounding information). Stated differently, in Embodiment 10, first imager A400 is an imager dedicated to imaging an area ahead of vehicle A1 and displaying the captured video on second display device A200, and first imager A400a is an imager dedicated to calculating the luminance and the chromaticity of the background. As described above, since first imager A400a dedicated to the calculation of the luminance and the chromaticity of the background is provided, it is possible to further improve the accuracy of luminance adjustment and chromaticity adjustment. In particular, since first imager A400a captures images of the area ahead of vehicle A1 via windshield A2 from inside the vehicle, it is possible to reflect, on the luminance adjustment and chromaticity adjustment, the luminance and the chromaticity of the background seen from inside the vehicle, which is preferable.

### Embodiment 11

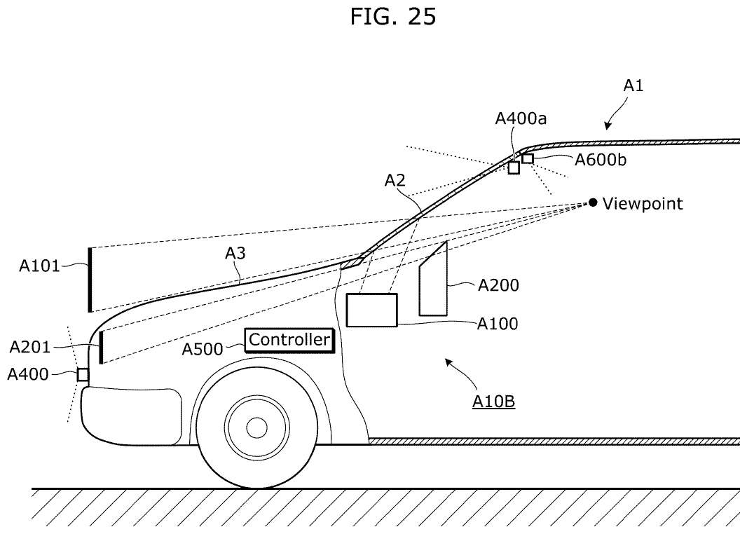

The following describes Embodiment 11. FIG. 25 is a schematic diagram showing display system A10B according to Embodiment 11. As shown in FIG. 25, display system A10B further includes second imager A600b that captures an image of the surroundings of the driver. Second imager A600b is disposed in the vicinity of the upper end of windshield A2 and captures an image of an area in the vicinity of the headrest of the driver's seat. Stated differently, when the driver is seated in the driver's seat, second imager A600b captures an image of the head of the driver. Controller A500 performs image processing, on the basis of the image captured by second imager A600b, to obtain information on the surroundings of the driver (user surrounding information). More specifically, controller A500 performs image processing on the image captured by second imager A600b to detect the viewpoint position of the driver and obtains such viewpoint position as the user surrounding information. Controller A500 estimates the luminance of the background when the driver is viewing first virtual image A101, on the basis of the viewpoint position. Controller A500 reflects such estimation result on the luminance adjustment performed on notification information AY110 and AY210. This achieves information notification that creates a lesser sense of discomfort.

In addition, controller A500 may adjust the size of each of notification information AY110 and AY210 between first display device A100 and second display device A200, on the basis of the user surrounding information obtained from second imager A600b. Controller A500 estimates a first distance between the driver and first virtual image A101 and a second distance between the driver and second virtual image A201, on the basis of the viewpoint position. Controller A500 reflects the first distance and the second distance on the size adjustment performed on notification information AY110 and AY210. This achieves information notification that creates a lesser sense of discomfort.

In addition, controller A500 may adjust the chromaticity of each of notification information AY110 and AY210 between first display device A100 and second display device A200, on the basis of the user surrounding information obtained from second imager A600b. More specifically, controller A500 performs image processing on the image captured by second imager A600b to detect the viewpoint position of the driver, and obtains such viewpoint position as the user surrounding information. Controller A500 estimates the chromaticity of the background when the driver is viewing first virtual image A101, on the basis of the viewpoint position. Controller A500 reflects such estimation result on the chromaticity adjustment performed on notification information AY110 and AY210. This achieves information notification that creates a lesser sense of discomfort.

### Embodiment 12

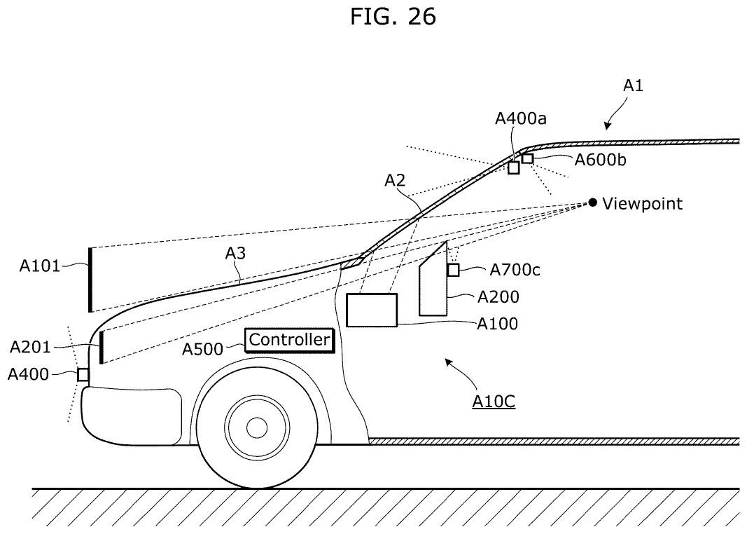

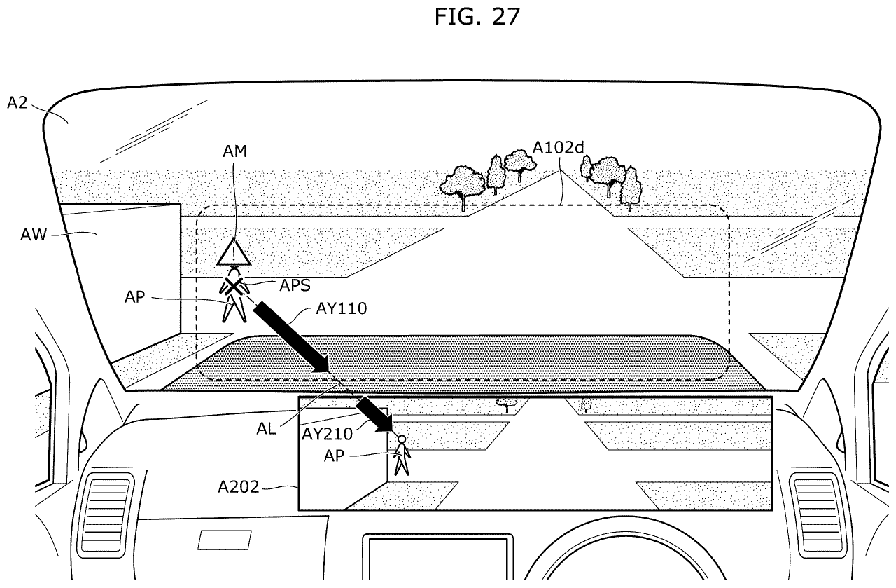

The following describes Embodiment 12. FIG. 26 is a schematic diagram showing display system A10C according to Embodiment 12. As shown in FIG. 26, display system A10C further includes illuminance sensor A700c that detects the illuminance of an area in the vicinity of second display device A200. More specifically, illuminance sensor A700c detects the illuminance of the area in the vicinity of the output port of second display device A200 from which video light is outputted. Controller A500 adjusts the luminance of each of notification information AY110 and AY210 between first display device A100 and second display device A200, on the basis of the detection result of illuminance sensor A700c. When the illuminance of the area in the vicinity of the output port of second display device A200 is high due to direct sunlight coming through windshield A2, for example, the luminance of notification information AY210 is increased such that the visibility of notification information AY210 will not decrease. Then, the luminance of notification information AY110 is adjusted accordingly. With this, it is possible to reflect the illuminance of the area in the vicinity of second display device A200 on the luminance of each of notification information AY110 and AY210. This enables information notification that creates a lesser sense of discomfort.

### Embodiment 13

The following describes Embodiment 13. FIG. 27 is an explanatory diagram showing an example of displaying notification information AY110 and AY210 according to Embodiment 13. Embodiment 9 has shown an example case where display reference point APS is set on center line ALc in the width direction of first display area A102 due to the reason that target object AP is present outside first display area A102. Embodiment 13 describes the case where the target object AP is present inside first display area A102.

In FIG. 27, the size of first display area A102d is set to be greater in the vertical direction and the width direction than the size of first display area A102 of Embodiment 9, but may be the same size. Controller A500 performs image processing on the image data captured by first imager A400 to recognize at least one target object included in such image data and detects the position coordinates, the size, etc. of such target object. Controller A500 extracts target object AP that is present inside first display area A102d when seen from the viewpoint of the driver (reference eyepoint). Controller A500 then generates notification information AY110 and AY210, on the basis of the position coordinates, the size, etc. of such target object AP extracted, and causes first display device A100 and second display device A200 to display notification information AY110 and AY210. In so doing, since target object AP is present inside first display area A102d, controller A500 sets such target object AP as display reference point APS. Controller A500 causes notification information AY110 and AY210 to be displayed on straight line AL that connects the position of the coordinates of target object AP inside second display area A202 and display reference point APS.

As described above, when target object AP is present inside first display area A102d, notification information AY110 and AY210 are displayed, with target object AP serving as display reference point APS. This enables the driver to also recognize actual target object AP simply by viewing notification information AY110 and AY210.

Also, as shown in FIG. 27, controller A500 also causes mark AM to be displayed in the vicinity of display reference point APS inside first display area A102d. This mark AM may be a mark for alerting or a mark for warning. Such mark AM enables the driver to more easily notice the occurrence of notification information AY110. The driver can freely change the display content, the display period, etc. of mark AM. Also, mark AM is not limited to being displayed in an upper portion of target object AP, and thus may be displayed anywhere.

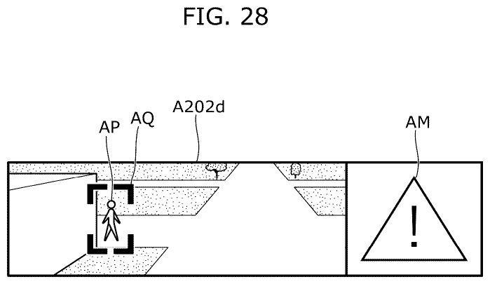

FIG. 28 is an explanatory diagram showing another example of displaying mark AM according to Embodiment 13. As shown in FIG. 28, second display area A202d may be divided into two parts, and the video captured by first imager A400, for example, may be displayed in one part, and mark AM may be displayed in the other part. In FIG. 28, frame AQ is displayed for target object AP to display target object AP in an emphasized manner. This emphasized display enables the driver to more easily notice target object AP.

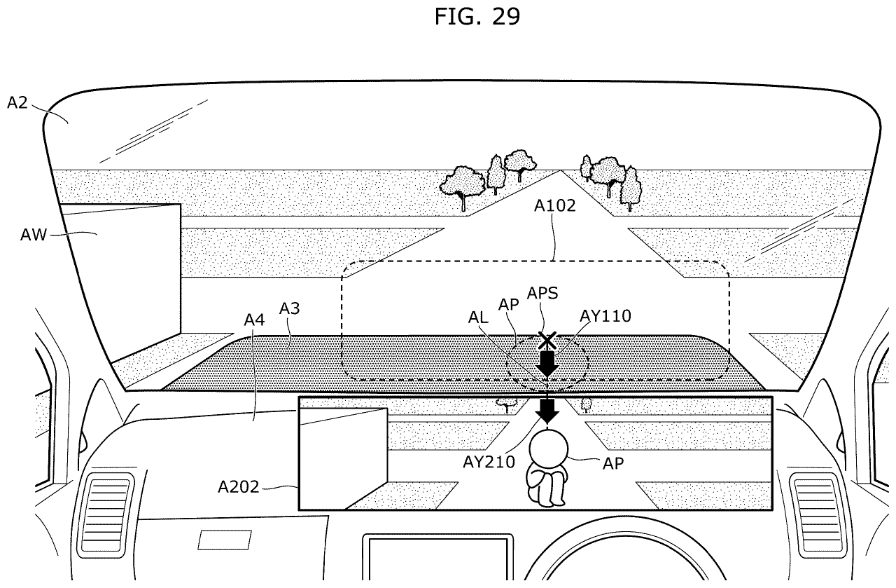

FIG. 29 is an explanatory diagram showing another example of displaying notification information AY110 and AY210 according to Embodiment 13. FIG. 29 shows the case where target object AP is squatting down in front of vehicle A1, for example, when the vehicle is about to start, and is invisible from the driver, although such target object AP is present within first display area A102. In this case, too, controller A500 performs image processing on the image data captured by first imager A400 to recognize target object AP, and detects the position coordinates, the size, etc. of such target object AP. Controller A500 extracts target object AP, which is hidden behind hood A3 when viewed from the viewpoint of the driver (reference eyepoint), but is present within first display area A102. Controller A500 generates notification information AY110 and AY210, on the basis of, for example, the position coordinates and the size of such target object AP extracted, and causes first display device A100 and second display device A200 to display notification information AY110 and AY210. In so doing, since target object AP is present inside first display area A102, controller A500 sets such target object AP as display reference point APS. Controller A500 causes notification information AY110 and AY210 to be displayed on straight line AL that connects the coordinate position of target object AP inside second display area A202 and display reference point APS.

As described above, even when target object AP that is invisible from the driver but is included in first display area A102 is present, it is possible to enable the driver to recognize target object AP by guiding the line of sight of the driver by means of notification information AY110 and AY210.

### Embodiment 14

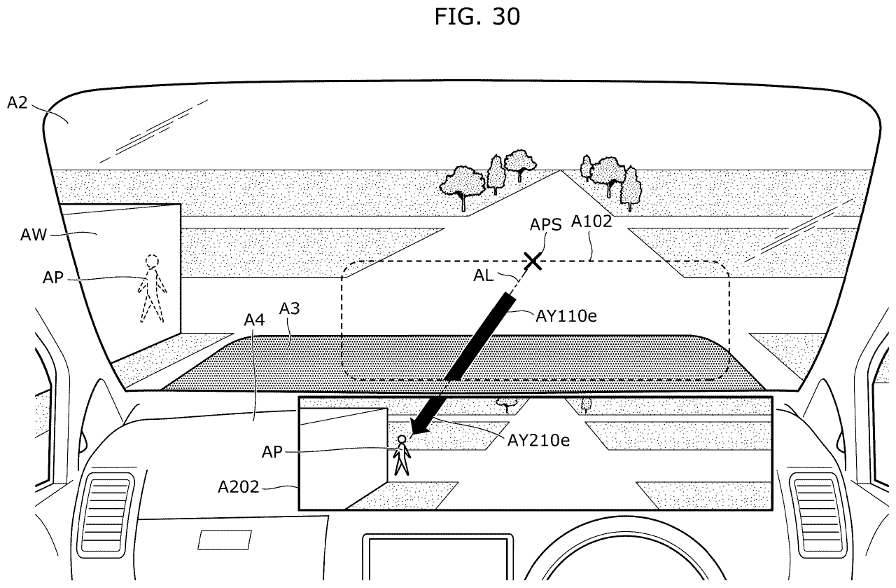

The following describes Embodiment 14. FIG. 30 is an explanatory diagram showing an example of displaying notification information AY110e and AY210e according to Embodiment 14. In Embodiment 14, controller A500 causes notification information AY110e displayed by first display device A100 and notification information AY210e displayed by second display device A200 to be displayed in a continuous manner. More specifically, as shown in FIG. 30, notification information AY110e and AY210e are represented in the form of a single arrow that spans first display area A102 and second display area A202. As described above, since notification information AY110e and AY210e are displayed in a continuous manner, it is possible to enable the driver to more easily recognize the positional relationship between notification information AY110e and AY210e.

### Embodiment 15

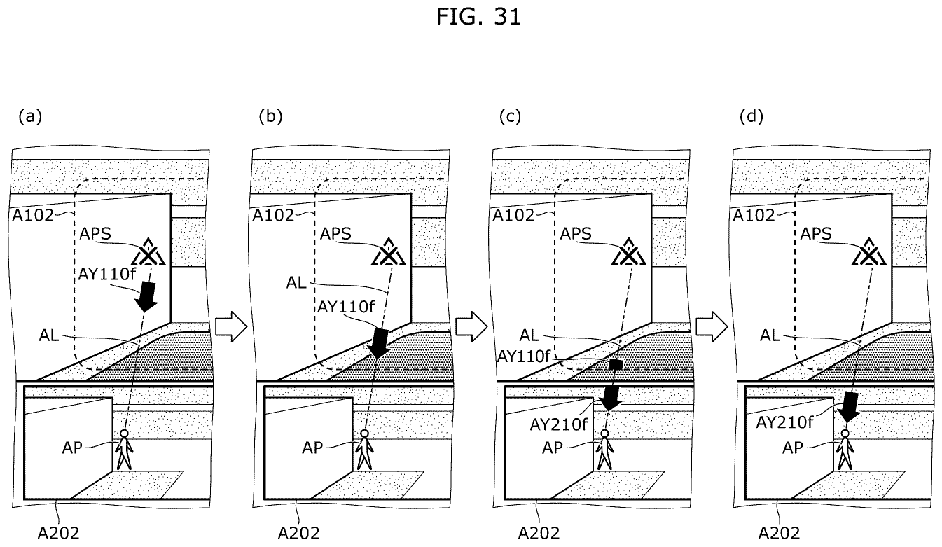

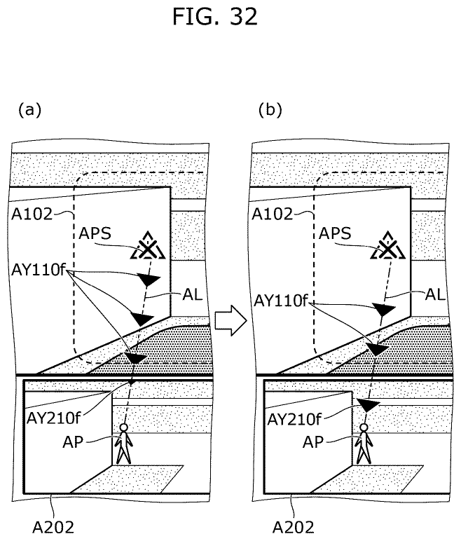

The following describes Embodiment 15. FIG. 31 is an explanatory diagram showing an example of displaying notification information AY110f and AY210f according to Embodiment 15. In Embodiment 15, controller A500 causes notification information AY110f displayed by first display device A100 and notification information AY210f displayed by second display device A200 to be displayed in a manner that these items of notification information move from first display area A102 to second display area A202.

For example, in the example shown in FIG. 31, notification information AY110f is first displayed in first display area A102 from display reference point APS along straight line AL, as shown in (a) in FIG. 31. Subsequently, notification information AY110f moves along straight line AL toward second display area A202, as shown in (b) in FIG. 31. Notification information AY110f and AY210f are then displayed, spanning first display area A102 and second display area A202 along straight line AL, as shown in (c) in FIG. 31. At this time, notification information AY110f and AY210f are represented in the form a single continuous arrow.

As described above, notification information AY110f displayed by first display device A100 and notification information AY210f displayed by second display device A200 are displayed in a manner that these items of notification information move from first display area A102 to second display area A202. This makes it easy to guide the line of sight of the driver.

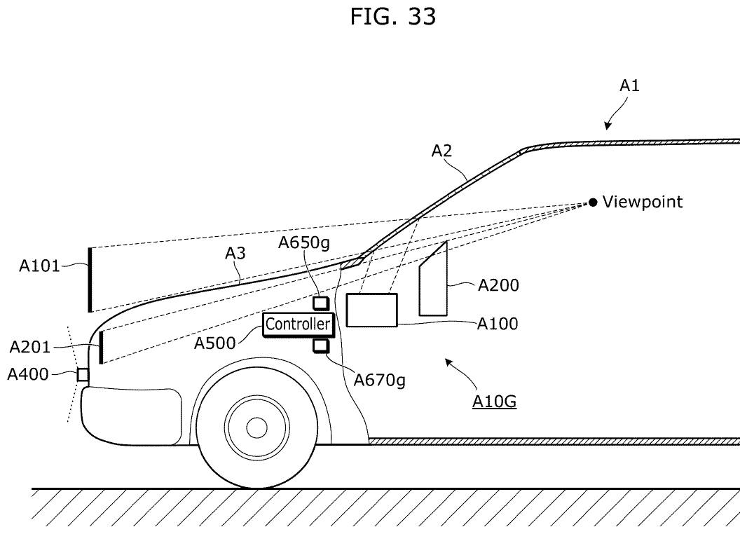

FIG. 32 is an explanatory diagram showing another example of displaying notification information AY110f and AY210f according to Embodiment 15. In the example shown in FIG. 32, notification information AY110f and AY210f are represented in the form of a plurality of triangles that are aligned on straight line AL. Notification information AY110f and AY210f are displayed in a manner that these items of notification information gradually move from first display area A102 to second display area A202 (transit from the state shown in (a) in FIG. 32 to the state shown in (b) in FIG. 32).

### Embodiment 16

The following describes Embodiment 16. FIG. 33 is a schematic diagram showing display system A10G according to Embodiment 16. As shown in FIG. 33, display system A10G further includes third imager A650g that captures images of lateral sides of vehicle A1, and tilt sensor A670g that detects a tilt of vehicle A1. Third imager A650g is provided, for example, on each of the left-side and right-side mirrors. Third imager A650g is an example of the side imager that captures images of the left side and the right side of vehicle A1. Controller A500 controls second display device A200 to cause it to display, in second display area A202, the video captured by third imager A650g.

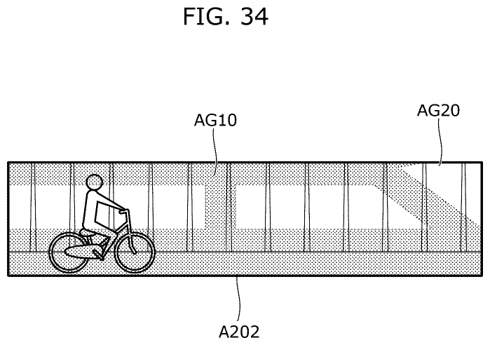

FIG. 34 is an explanatory diagram showing an example of the display performed by second display device A200 according to Embodiment 16. As shown in FIG. 34, controller A500 causes second display device A200 to display pseudo image AG10, which mimics the interior of vehicle A1, as a blind spot portion of the driver who is seeing a lateral side of vehicle A1, in a manner that such pseudo image AG10 is overlaid on video AG20 captured by third imager A650g. Pseudo image AG10 is represented in the form of a transparent image (represented with dot hatching in FIG. 34) for the driver to be able to view video AG20. With this, it is possible for the driver to view pseudo image AG10 and video AG20 displayed in second display area A202 of second display device A200. This enables the driver to recognize the situations of the lateral sides of vehicle A1 and blind spots, and have a grasp of the surrounding situation of vehicle A1.

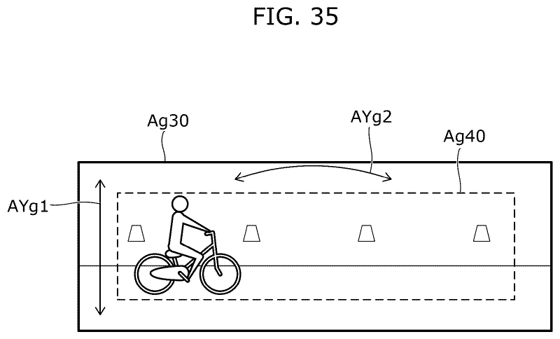

Controller A500 may also correct video AG20 captured by third imager A650g, on the basis of the detection result of tilt sensor A670g, and cause second display device A200 to display the corrected video AG20. FIG. 35 is an explanatory diagram showing an example of displaying video AG20 according to Embodiment 16. In FIG. 35, the black frame indicates imaging range Ag30 of third imager A650g, and the dashed line frame indicates display range Ag40 displayed in second display area A202 of second display device A200. When tilt sensor A670g detects a tilt of vehicle A1 in the roll direction, for example, controller A500 causes display range Ag40 to move in the up-down direction within imaging range Ag30 (see arrow AYg1), on the basis of such detection result, and corrects video AG20. Also, when tilt sensor A670g detects a tilt of vehicle A1 in the pitch direction, controller A500 causes display range Ag40 to rotate within imaging range Ag30 (see arrow AYg2), on the basis of such detection result, and corrects video AG20. As described above, since video AG20 that has been corrected on the basis of the detection result of tilt sensor A670g is displayed by second display device A200, it is possible for the driver to have a more accurate grasp of the surrounding situation of vehicle A1.

Furthermore, controller A500 may perform image processing on video AG20 captured by third imager A650g to detect target object AP1. In this case, controller A500 may cause target object AP1 to be displayed in an emphasized manner.

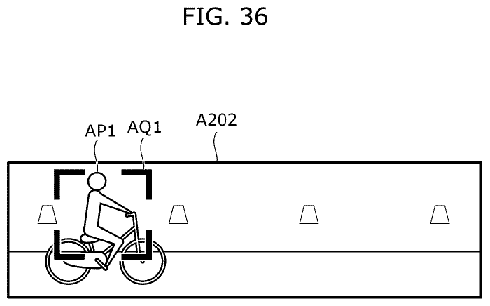

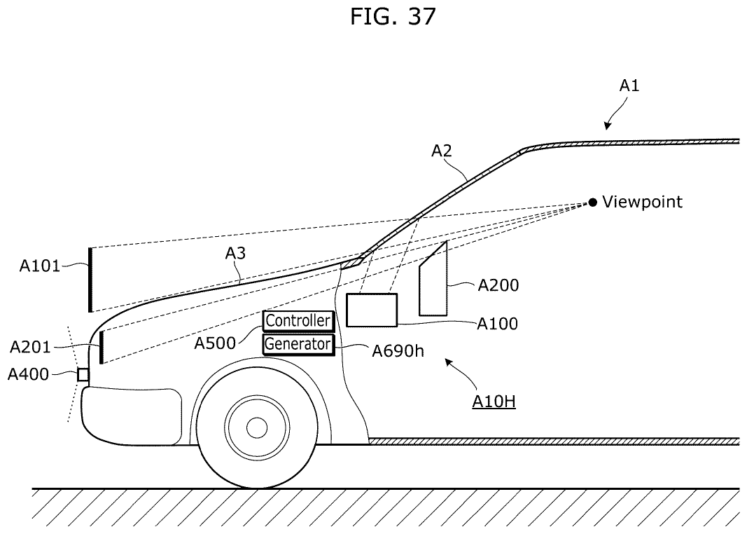

FIG. 36 is an explanatory diagram showing another example of the display according to Embodiment 16. As shown in FIG. 36, controller A500 may control second display device A200 to cause it to display frame AQ1 for target object AP1 inside second display area A202, thereby displaying target object AP1 in an emphasized manner. This emphasized display enables the driver to easily notice target object AP1. Note that FIG. 36 omits the illustration of pseudo image AG10 shown in second display area A202.

### Embodiment 17

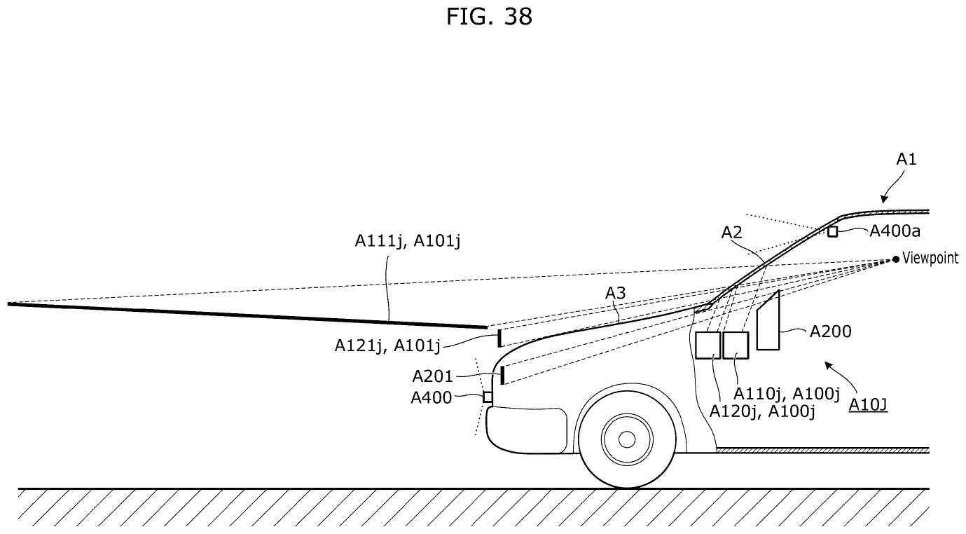

The following describes Embodiment 17. FIG. 37 is a schematic diagram showing display system A10H according to Embodiment 17. As shown in FIG. 37, display system A10H further includes generator A690h that generates a sound or a vibration. When generator A690h is intended for generating a sound, examples of generator A690h include a speaker. When generator A690h is intended for generating a vibration, examples of generator A690h include a vibration generator that causes the steering wheel to vibrate and a vibration generator that causes the driver's seat to vibrate. Controller A500 controls generator A690h to cause it to generate the sound or the vibration, on the basis of the display timing of notification information AY110 and AY210. With this, it is possible for the driver to more reliably have a grasp of notification information AY110 and AY210 in response to the sound or the vibration from generator A690h.

### Embodiment 18

The following describes Embodiment 18. FIG. 38 is a schematic diagram showing display system A10J according to Embodiment 18. As shown in FIG. 38, first display device A100j of display system A10J includes AR-HUD A110j and HUD A120j. Stated differently, first virtual image A101j displayed by first display device A100j is formed by AR-HUD A110j and HUD A120j. This enables more diverse representation of first virtual image A101j.

More specifically, AR-HUD A110j displays one portion A111j of first virtual image A101j. HUD A120j displays other portion A121j of first virtual image A101j. One portion A111j of first virtual image A101j is located at an angle such that one portion A111j is located upward, toward the front of vehicle A1. Other portion A121j of first virtual image A101j is located below such one portion A111j to be parallel to the up-down direction of vehicle A1.

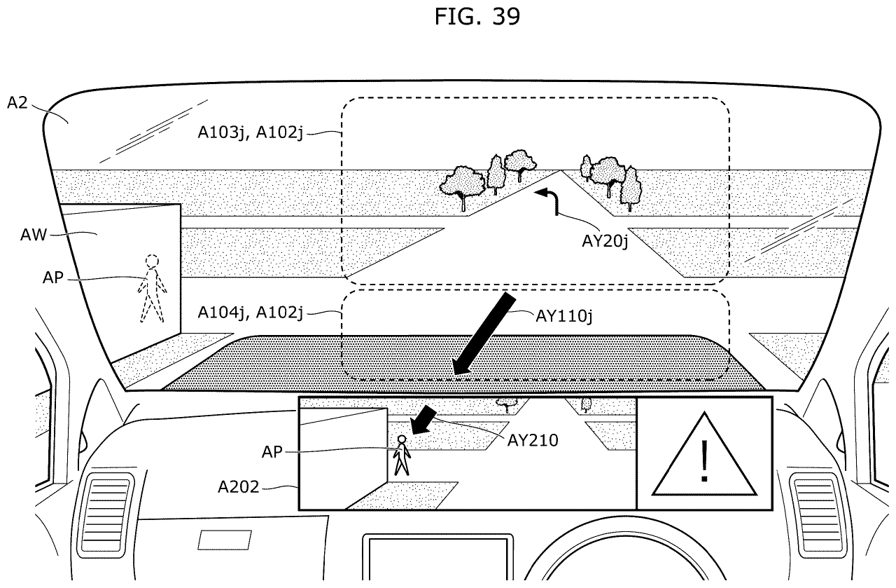

FIG. 39 is an explanatory diagram showing an example of displaying notification information AY110j according to Embodiment 18. In FIG. 39, first display area A102j is vertically divided into two parts, and upper area A103j corresponds to one portion A111j of first virtual image A101j, and lower area A104j corresponds to other portion A121j of first virtual image A101j. In FIG. 39, navigation graphics AY20j is displayed in one portion A111j of first virtual image A101j. Also, notification information AY110j is displayed in other portion A121j of first virtual image A101j.

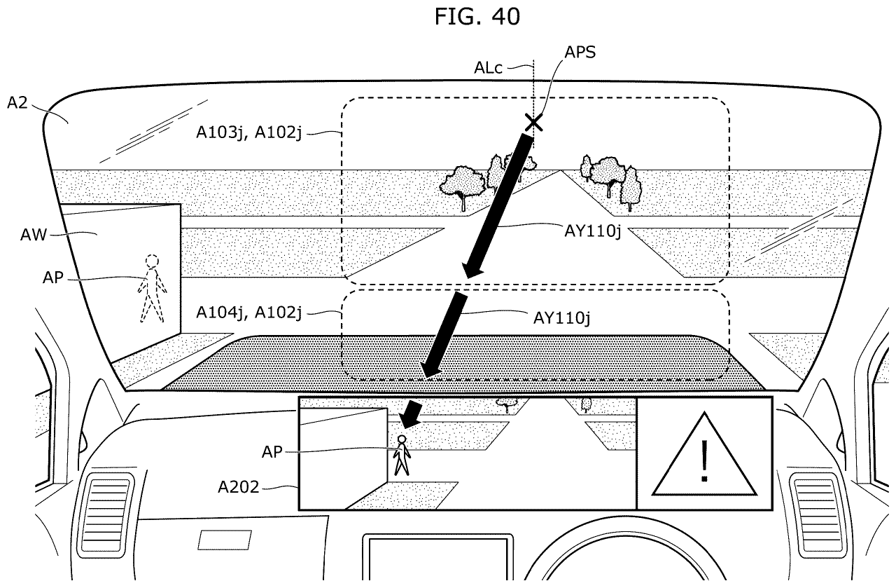

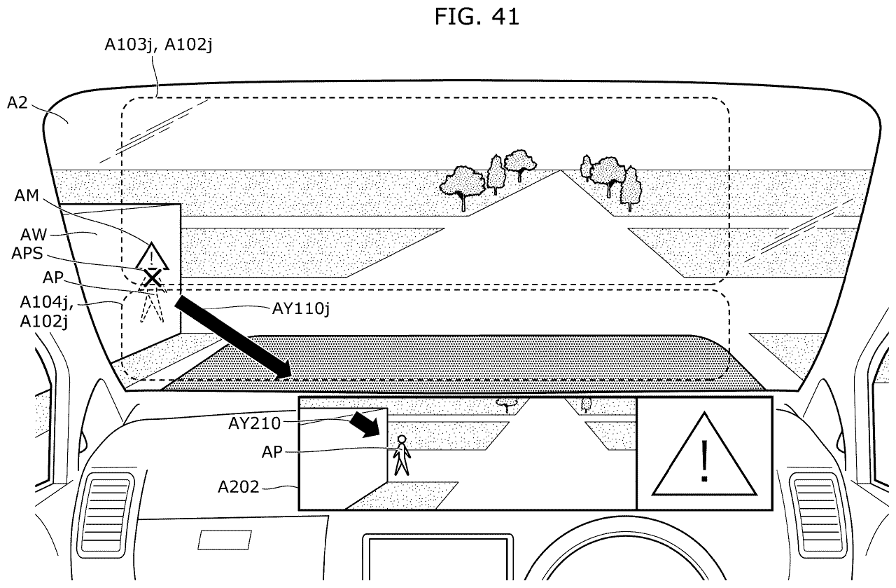

FIG. 40 and FIG. 41 are explanatory diagrams showing other examples of displaying notification information AY110j according to Embodiment 18. As shown in FIG. 40, notification information AY110j displayed by first display device A100j may be displayed in a divided manner in upper area A103j and lower area A104j. In this case, since target object AP is present outside first display area A102j, display reference point APS is set on center line ALc in the width direction (width direction of the vehicle) in upper area A103j.

In the case shown in FIG. 41, since target object AP is present inside lower area A104j, notification information AY110j may be displayed in lower area A104j, with such target object AP serving as display reference point APS. Note that in FIG. 41, mark AM is shown in upper area A103j. As described above, depending on the position of target object AP, mark AM and AY110j may be displayed in a divided manner in upper area A103j and lower area A104j.

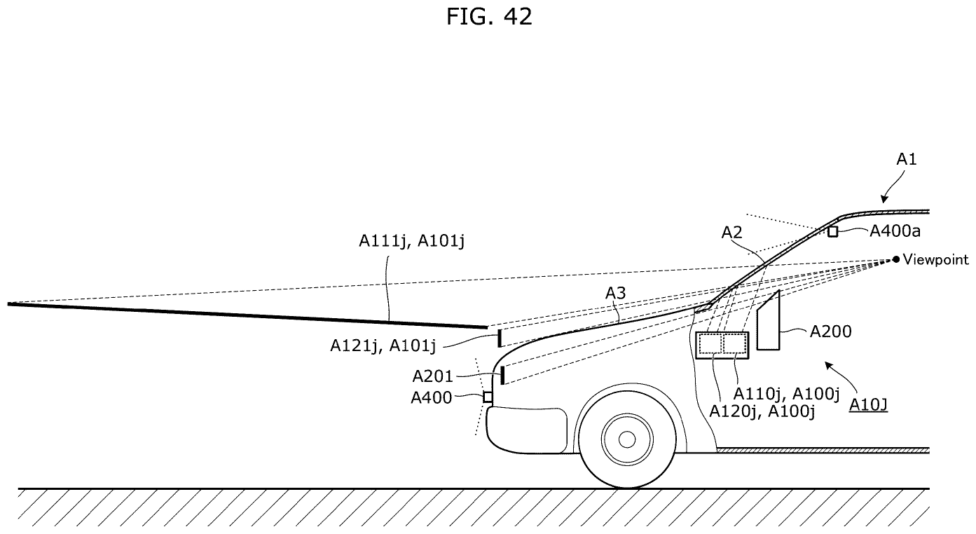

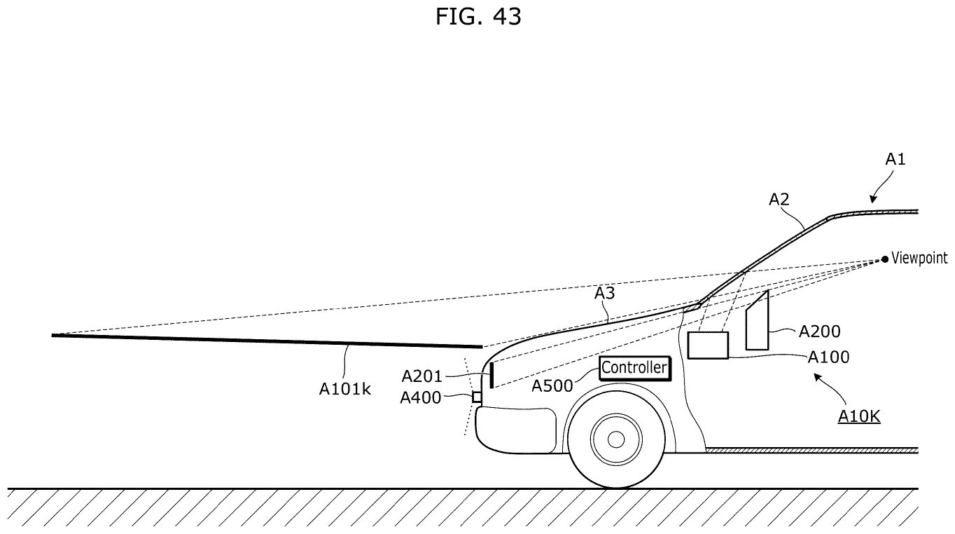

FIG. 42 is a schematic diagram showing another example of display system A10J according to Embodiment 18. As shown in FIG. 42, AR-HUD A110j and HUD A120j may be integrally configured. Stated differently, one portion A111j of first virtual image A101j and other portion A121j of first virtual image A101j may be projected from a single device.

### Embodiment 19

The following describes Embodiment 19. FIG. 43 is a schematic diagram showing display system A10K according to Embodiment 19. As shown in FIG. 43, first virtual image A101k may be inclined in an orientation in which the upper end portion is located forward in the traveling direction of vehicle A1 and the lower end portion is located rearward in the traveling direction of vehicle A1. Stated differently, the entirety of first virtual image A101k may be an image of AR-HUD A110j described in Embodiment 18. This enables first virtual image A101k to display video that creates a sense of depth in the eyes of the driver in the forward direction of vehicle A1. Since it is possible to display the notification information from the back toward the front, the driver's visibility is improved and a sense of discomfort is further reduced.

### Embodiment 20

The following describes Embodiment 20. Embodiment 20 describes a variation of the first display device and the second display device.

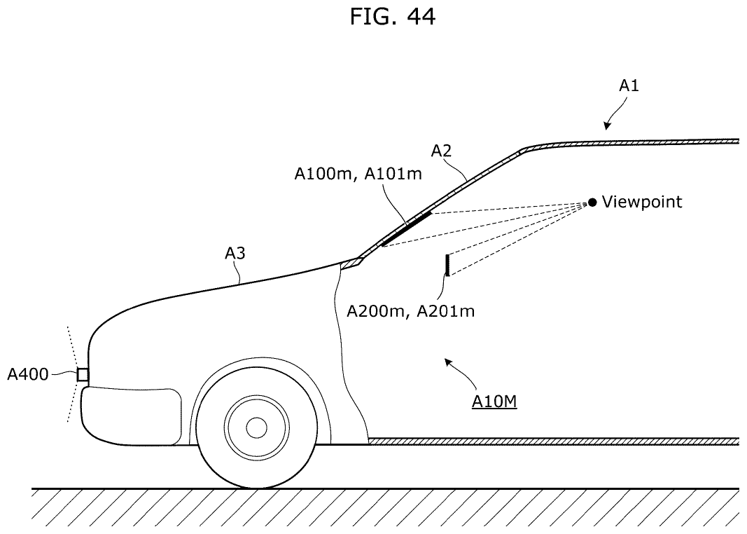

FIG. 44 is a schematic diagram showing display system A10M according to Embodiment 20. As shown in FIG. 44, first display device A100m is a transmissive display laminated on windshield A2 and displays first image A101m. The transmissive display is, for example, a transparent organic EL display. Second display device A200m is a liquid crystal display and displays second image A201m. As described above, first display device A100m and second display device A200m may be display devices that do not project virtual images.

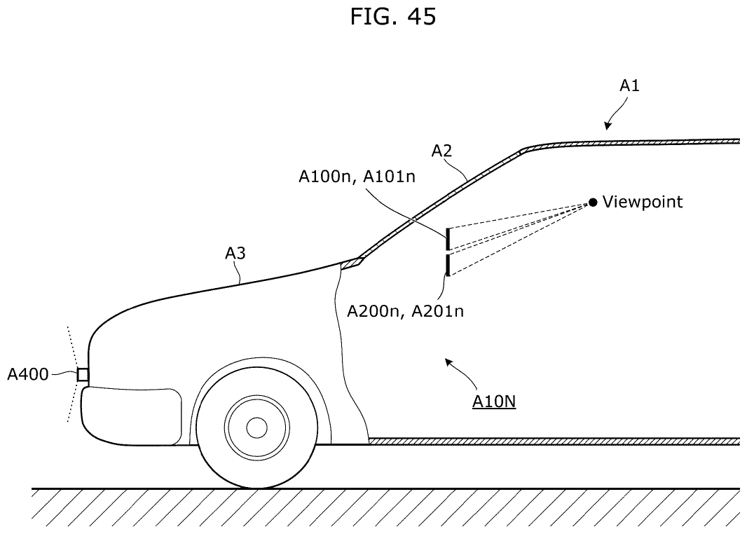

FIG. 45 is a schematic diagram showing display system A10N according to Embodiment 20. As shown in FIG. 45, first display device A100n is a transmissive display that is disposed closer to the interior side than windshield A2 is, and displays first image A101n. Second display device A200n is a liquid crystal display and displays second image A201n. As described above, first display device A100n and second display device A200n may be display devices that do not project virtual images.

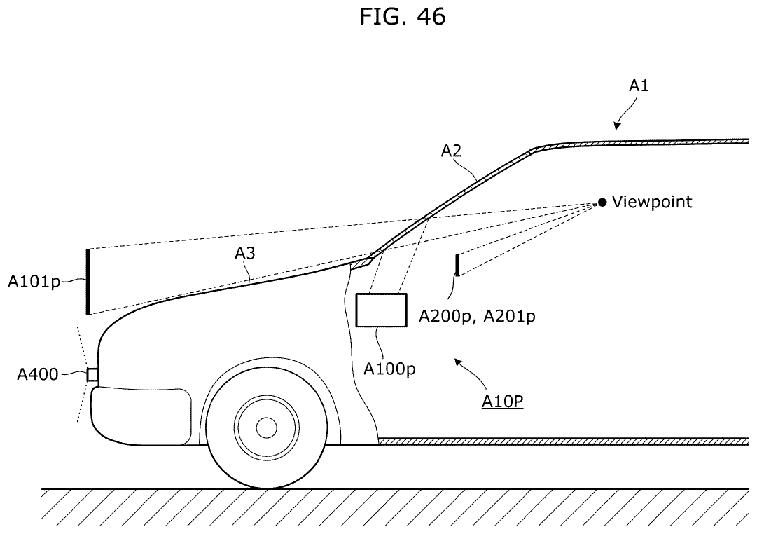

FIG. 46 is a schematic diagram showing display system A10P according to Embodiment 20. As shown in FIG. 46, first display device A100p is a HUD, and projects first virtual image A101P ahead of vehicle A1. Second display device A200p is a liquid crystal display that displays second image A201p.

Note that, the configuration of FIG. 46 may be reversed, and the first display device may be a display that does not project virtual images, and the second display device may be a display that displays virtual images. Sated differently, the first display device and the second display device may be displays, at least one of which projects virtual images, or both of which do not project virtual images.

### (Others)

The display system according to one or more aspects of the present disclosure has been described above on the basis of the embodiments, but the present disclosure is not limited to these embodiments. The scope of one or more aspects of the present disclosure may also include an embodiment achieved by making various modifications to the embodiments that can be conceived by those skilled in the art and an embodiment achieved by freely combining some of the elements in different embodiments without departing from the essence of the present disclosure.

For example, the foregoing embodiments have shown examples in which the imagers that image the surroundings of vehicle A1 are first imager A400, first imager A400a, and third imager A650g. However, an imager that captures an image of the rear of vehicle A1, an all-sky imager attached to the ceiling of vehicle A1, and a wide-angle imager may also be used as the imagers. Two or more of these imagers may be used to switch videos, depending on the direction in which target object AP is located. With this, it is possible to display a clearer video.

### (Added Note)

From the embodiments and so forth described above, techniques described below are disclosed.

### [Technique 1]

A display system including:
a first display device that projects a first virtual image ahead of a user in a vehicle; and
a second display device that projects a second virtual image ahead of the user and below the first virtual image,
wherein a lower end of the first virtual image and an upper end of the second virtual image are located within a circle whose diameter is a length of the second virtual image in a side view.

### [Technique 2]

The display system according to Technique 1,
wherein a difference between a first angle of depression and a second angle of depression is 12° or less, the first angle of depression being an angle formed by the lower end of the first virtual image with respect to a viewpoint of the user, the second angle of depression being an angle formed by the upper end of the second virtual image with respect to the viewpoint of the user.

### [Technique 3]

The display system according to Technique 1 or 2, including:
a third display device that projects a third virtual image ahead of the user,
wherein the third virtual image is located at a viewing distance of 0.25 diopters or less with respect to a viewing distance of the second virtual image.

### [Technique 4]

The display system according to any one of Techniques 1 to 3,
wherein at least one of the first virtual image projected by the first display device or the second virtual image projected by the second display device is displayed in a plurality of layers.

### [Technique 5]

The display system according to any one of Techniques 1 to 4,
wherein the second display device includes:
   a display element that emits video light for forming the second virtual image; and
   an optical system for projecting the video light from the display element as the second virtual image, and
the optical system includes a concave mirror that reflects the video light at a final stage.

### [Technique 6]

The display system according to any one of Techniques 1 to 5,
wherein at least one of the first display device or the second display device includes an adjuster for adjusting the viewing distance of the first virtual image and the viewing distance of the second virtual image.

### [Technique 7]

The display system according to any one of Techniques 1 to 6, including:
a controller that controls a display content of the first display device and a display content of the second display device.

### [Technique 8]

The display system according to any one of Techniques 1 to 7,
wherein at least one of the first display device or the second display device includes an optical system that includes a hologram element.

### [Technique 9]

The display system according to any one of Techniques 1 to 8, including:
a first position adjuster that adjusts a first display position in an up-down direction of the first virtual image;
a second position adjuster that adjusts a second display position in an up-down direction of the second virtual image; and
a coordinate changer that changes coordinates of the first virtual image within a displayable range of the first virtual image, based on the first display position and the second display position that have been adjusted.

### [Technique 10]

The display system according to Technique 9,
wherein the first display device includes a first reflector that reflects video light for forming the first virtual image,
the second display device includes a second reflector that reflects video light for forming the second virtual image,
the first position adjuster adjusts at least one of an orientation or a position of the first reflector to adjust the first display position of the first virtual image, and
the second position adjuster adjusts at least one of an orientation or a position of the second reflector to adjust the second display position of the second virtual image.

### [Technique 11]

The display system according to claim 9 or 10, including:
a head imager that captures an image of a head of the user;
an estimator that estimates a viewpoint position of the user, based on the image captured by the head imager; and
an adjustment controller that controls the first position adjuster and the second position adjuster, based on the viewpoint position of the user estimated.

### [Technique 12]

The display system according to any one of Techniques 1 to 11, including:
a first imager that captures images of surroundings of the vehicle; and
a controller that controls the first display device, the second display device, and the first imager,
wherein when the controller causes each of the first display device and the second display device to display notification information to be provided to the user, the controller adjusts, between the first display device and the second display device, at least one of luminance, a size, or chromaticity of the notification information to be displayed together with vehicle surrounding information obtained from the first imager.

### [Technique 13]

The display system according to Technique 12,
wherein the first imager captures the images of an area ahead of the vehicle, and
the controller calculates luminance of the first virtual image in a state of being overlaid on a background, based on the vehicle surrounding information, and adjusts the luminance of the notification information between the first display device and the second display device, based on a calculation result.

### [Technique 14]

The display system according to Technique 12 or 13,
wherein the controller adjusts the luminance of the notification information between the first display device and the second display device to cause the luminance of the notification information in the first virtual image and the luminance of the notification information in the second virtual image to be approximately same.

### [Technique 15]

The display system according to Technique 12 or 13,
wherein the controller adjusts the luminance of the notification information between the first display device and the second display device to cause the luminance of the notification information in the first virtual image to be higher than the luminance of the notification information in the second virtual image.

### [Technique 16]

The display system according to Technique 12 or 13,
wherein the controller adjusts the luminance of the notification information between the first display device and the second display device to cause the luminance of the notification information in the first virtual image to be lower than the luminance of the notification information in the second virtual image.

### [Technique 17]

The display system according to any one of Techniques 12 to 16, including:
a second imager that captures an image of surroundings of the user,
wherein the controller adjusts the luminance of the notification information between the first display device and the second display device, based on user surrounding information obtained from the second imager.

### [Technique 18]

The display system according to any one of Techniques 12 to 16, including:
an illuminance sensor that detects an illuminance of an area in the vicinity of the second display device,
wherein the controller adjusts the luminance of the notification information between the first display device and the second display device, based on a detection result of the illuminance sensor.

### [Technique 19]

The display system according to any one of Techniques 12 to 18, including:
a second imager that captures an image of surroundings of the user,
wherein the controller adjusts the size of the notification information between the first display device and the second display device, based on user surrounding information obtained from the second imager.

### [Technique 20]

The display system according to any one of Techniques 12 to 19,
wherein the first imager captures the images of an area ahead of the vehicle, and
the controller calculates chromaticity of the first virtual image in a state of being overlaid on a background, based on the vehicle surrounding information, and adjusts, between the first display device and the second display device, the chromaticity of the notification information in the first virtual image and the chromaticity of the notification information in the second virtual image to be approximately same, based on a calculation result.

### [Technique 21]

The display system according to any one of Techniques 12 to 19,
wherein the controller adjusts the chromaticity of the notification information in the first virtual image, with the chromaticity of the notification information in the second virtual image kept constant.

### [Technique 22]

The display system according to any one of Techniques 12 to 19,
wherein the controller adjusts the chromaticity of the notification information in the second virtual image to be approximately same as the chromaticity of the notification information in the first virtual image, with the chromaticity of the notification information in the first virtual image kept constant.

### [Technique 23]

The display system according to any one of Techniques 20 to 22, including:
a second imager that captures an image of surroundings of the user,
wherein the controller adjusts the chromaticity the notification information between the first display device and the second display device, based on user surrounding information obtained from the second imager.

### [Technique 24]

The display system according to any one of Techniques 12 to 23,
wherein the controller causes the notification information to be displayed, based on a display reference point that is set inside a first display area of the first display device,
when a target object for which the notification information is provided is present inside the first display area, the controller sets the target object as the display reference point, and
when the target object for which the notification information is provided is present outside the first display area, the controller sets the display reference point on a center line in a width direction of the first display area.

### [Technique 25]

The display system according to Technique 24,
wherein the controller causes the notification information displayed by the first display device and the notification information displayed by the second display device to be located on a straight line that includes the display reference point.

### [Technique 26]

The display system according to Technique 25,
wherein the controller causes the notification information displayed by the first display device and the notification information displayed by the second display device to be displayed in a continuous manner.

### [Technique 27]

The display system according to Technique 25,
wherein the controller causes the notification information displayed by the first display device and the notification information displayed by the second display device to be displayed in a manner that each of the notification information displayed by the first display device and the notification information displayed by the second display device moves from the first display area of the first display device toward a second display area of the second display device.

### [Technique 28]

The display system according to any one of Techniques 12 to 27,
wherein the controller causes the second display device to display video captured by the first imager.

### [Technique 29]

The display system according to any one of Techniques 12 to 28, including:
a third imager that captures video of surroundings of a lateral side of the vehicle,
wherein the controller causes the second display device to display a pseudo image overlaid on the video captured by the third imager, the pseudo image being an image that mimics an interior of the vehicle as a blind spot of the user.

### [Technique 30]

The display system according to Technique 29, including:
a tilt sensor that obtains a tilt of the vehicle,
wherein the controller corrects the video captured by the third imager, based on a detection result of the tilt sensor, and causes the second display device to display the video corrected.

### [Technique 31]

The display system according to any one of Techniques 12 to 30, including:
a generator that generates a sound or a vibration,
wherein the controller causes the generator to generate the sound or the vibration, based on a display timing of the notification information.

### [Technique 32]

The display system according to any one of Techniques 1 to 31,
wherein the first display device includes: an augmented reality head-up display that projects one portion of the first virtual image; and a head-up display that projects another portion of the first virtual image.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2024-031098 filed on Mar. 1, 2024, Japanese Patent Application No. 2024-031110 filed on Mar. 1, 2024, and Japanese Patent Application No. 2024-154389 filed on Sep. 9, 2024.

### INDUSTRIAL APPLICABILITY

The present disclosure is applicable for use as a display system for displaying images.

1. A display system comprising:
a first display device that projects a first virtual image ahead of a user in a vehicle; and
a second display device that projects a second virtual image ahead of the user and below the first virtual image,
wherein a lower end of the first virtual image and an upper end of the second virtual image are located within a circle whose diameter is a length of the second virtual image in a side view.

2. The display system according to claim 1,
wherein a difference between a first angle of depression and a second angle of depression is 12° or less, the first angle of depression being an angle formed by the lower end of the first virtual image with respect to a viewpoint of the user, the second angle of depression being an angle formed by the upper end of the second virtual image with respect to the viewpoint of the user.

3. The display system according to claim 1, comprising:
a third display device that projects a third virtual image ahead of the user,
wherein the third virtual image is located at a viewing distance of 0.25 diopters or less with respect to a viewing distance of the second virtual image.

4. The display system according to claim 1,
wherein at least one of the first virtual image projected by the first display device or the second virtual image projected by the second display device is displayed in a plurality of layers.

5. The display system according to claim 1,
wherein the second display device includes:
a display element that emits video light for forming the second virtual image; and
an optical system for projecting the video light from the display element as the second virtual image, and
the optical system includes a concave mirror that reflects the video light at a final stage.

6. The display system according to claim 1, comprising:
a first position adjuster that adjusts a first display position in an up-down direction of the first virtual image;
a second position adjuster that adjusts a second display position in an up-down direction of the second virtual image; and
a coordinate changer that changes coordinates of the first virtual image within a displayable range of the first virtual image, based on the first display position and the second display position that have been adjusted.

7. The display system according to claim 6,
wherein the first display device includes a first reflector that reflects video light for forming the first virtual image,
the second display device includes a second reflector that reflects video light for forming the second virtual image,
the first position adjuster adjusts at least one of an orientation or a position of the first reflector to adjust the first display position of the first virtual image, and
the second position adjuster adjusts at least one of an orientation or a position of the second reflector to adjust the second display position of the second virtual image.

8. The display system according to claim 6, comprising:
a head imager that captures an image of a head of the user;
an estimator that estimates a viewpoint position of the user, based on the image captured by the head imager; and
an adjustment controller that controls the first position adjuster and the second position adjuster, based on the viewpoint position of the user estimated.

9. The display system according to claim 1, comprising:
a first imager that captures images of surroundings of the vehicle; and
a controller that controls the first display device, the second display device, and the first imager,
wherein when the controller causes each of the first display device and the second display device to display notification information to be provided to the user, the controller adjusts, between the first display device and the second display device, at least one of luminance, a size, or chromaticity of the notification information to be displayed together with vehicle surrounding information obtained from the first imager.

10. The display system according to claim 9,
wherein the first imager captures the images of an area ahead of the vehicle, and
the controller calculates luminance of the first virtual image in a state of being overlaid on a background, based on the vehicle surrounding information, and adjusts the luminance of the notification information between the first display device and the second display device, based on a calculation result.

11. The display system according to claim 9,
wherein the controller adjusts the luminance of the notification information between the first display device and the second display device to cause the luminance of the notification information in the first virtual image and the luminance of the notification information in the second virtual image to be approximately same.

12. The display system according to claim 9,
wherein the first imager captures the images of an area ahead of the vehicle, and
the controller calculates chromaticity of the first virtual image in a state of being overlaid on a background, based on the vehicle surrounding information, and adjusts, between the first display device and the second display device, the chromaticity of the notification information in the first virtual image and the chromaticity of the notification information in the second virtual image to be approximately same, based on a calculation result.

13. The display system according to claim 9,
wherein the controller adjusts the chromaticity of the notification information in the first virtual image, with the chromaticity of the notification information in the second virtual image kept constant.

14. The display system according to claim 9,
wherein the controller causes the notification information to be displayed, based on a display reference point that is set inside a first display area of the first display device,
when a target object for which the notification information is provided is present inside the first display area, the controller sets the target object as the display reference point, and
when the target object for which the notification information is provided is present outside the first display area, the controller sets the display reference point on a center line in a width direction of the first display area.

15. The display system according to claim 14,
wherein the controller causes the notification information displayed by the first display device and the notification information displayed by the second display device to be located on a straight line that includes the display reference point.

16. The display system according to claim 15,
wherein the controller causes the notification information displayed by the first display device and the notification information displayed by the second display device to be displayed in a continuous manner.

17. The display system according to claim 15,
wherein the controller causes the notification information displayed by the first display device and the notification information displayed by the second display device to be displayed in a manner that each of the notification information displayed by the first display device and the notification information displayed by the second display device moves from the first display area of the first display device toward a second display area of the second display device.

18. The display system according to claim 9,
wherein the controller causes the second display device to display video captured by the first imager.

19. The display system according to claim 9, comprising:
a side imager that captures video of surroundings of a lateral side of the vehicle,
wherein the controller causes the second display device to display a pseudo image overlaid on the video captured by the side imager, the pseudo image being an image that mimics an interior of the vehicle as a blind spot of the user.

20. The display system according to claim 9, comprising:
a generator that generates a sound or a vibration,
wherein the controller causes the generator to generate the sound or the vibration, based on a display timing of the notification information.
